(19) United States
(12) Patent Application Publication
(10) Pub. No.: US 2022/0137379 A1
(43) Pub. Date: May 5, 2022

(54) ZOOM LENS AND IMAGE PICKUP APPARATUS

(71) Applicant: CANON KABUSHIKI KAISHA, Tokyo (JP)

(72) Inventor: Masao Hori, Tochigi (JP)

(21) Appl. No.: 17/511,405

(22) Filed: Oct. 26, 2021

(30) Foreign Application Priority Data
Nov. 2, 2020 (JP) 2020-183668

(51) Int. Cl. G02B 15/14

(52) U.S. Cl. CPC G02B 15/144113; G02B 15/145125

(57) ABSTRACT

A zoom lens includes in order from object side: a positive first unit not moving for zooming; a negative second unit moving in an optical axis direction for zooming; a positive M unit moving in the optical axis direction for zooming; and a positive R unit disposed closest to the image side, wherein the first unit includes a subunit moving for focusing, wherein the zoom lens includes an aperture stop closer to the image side than the second unit, wherein a length on the optical axis from a surface of the R unit closest to the object side to a surface of the R unit closest to an image side, a length on the optical axis from the surface of the R unit closest to an image side to a rear principal point of the R unit, and a back focus of the zoom lens are defined.

### BACKGROUND

### Field of the Disclosure

The aspect of the embodiments relates to a zoom lens and an image pickup apparatus.

### Description of the Related Art

With the recent increase in the resolution and the size of image pickup sensor, an image sensor with which a so-called SHV (super high-vision) image pickup such as 4K or 8K shooting, which is smaller than the conventional 4K image pickup sensor with the S35 mm format, has been put into practical use. In order to cope with this, there has been a demand for a compact and lightweight SHV-compatible interchangeable lens that satisfies the restriction of the diameter around the mount while ensuring a sufficient back focus.

Under such background, a zoom lens with a high magnification, a wide view angle and a high optical performance is requested in an image pickup apparatus such as the recent television camera, silver-halide film camera, digital camera, video camera, and the like. As such a zoom lens, a zoom lens of positive lead type including a lens unit having a positive refractive power disposed on the most object side and including four or more lens units in total is known.

Japanese Patent Application Laid-Open No. 2008-107448 discloses a five-unit zoom lens including a first lens unit having a positive refractive power, a second lens unit having a negative refractive power, a third lens unit having a positive refractive power, a fourth lens unit having a positive refractive power, and a fifth lens unit having a positive refractive power, with an angle of view at wide angle end of about 62 degrees and a zoom ratio of about 4.5. Japanese Patent Application Laid-Open No. 561-270717 discloses a five-unit zoom lens including a first lens unit having a positive refractive power, a second lens unit having a negative refractive power, a third lens unit having a negative refractive power, a fourth lens unit having a positive refractive power, and a fifth lens unit having a positive refractive power, with an angle of view at wide angle end of about 27 degrees and a zoom ratio of about 11.3.

Conventionally, in order to secure a long back focus, since a lens unit having a strong negative power and a lens unit having a strong positive refractive power are disposed on the image side of a lens unit having a positive refractive power in an object side of a relay lens unit having an imaging action as a rearest lens unit in the zoom lens to secure a retrofocus configuration, and therefore, compatibility with downsizing and weight reduction of lenses was limited.

### SUMMARY OF THE DISCLOSURE

The aspect of the embodiments provides a zoom lens, includes in order from an object side to an image side: a first lens unit having a positive refractive power and configured not to move for zooming; a second lens unit having a negative refractive power and configured to move in an optical axis direction for zooming; an M lens unit having a positive refractive power and configured to move in the optical axis direction for zooming; and an R lens unit having a positive refractive power and disposed closest to the image side,

wherein the first lens unit includes a lens subunit configured to move for focusing,

wherein the zoom lens includes an aperture stop in closer to the image side than the second lens unit,

wherein following inequalities are satisfied:

0.65≤Sk/DR≤1.4, and

0.1<Ok/Sk<0.6,

where DR represents a length on the optical axis from a surface of the R lens unit to a surface closest to an image side of the R lens unit closest to the object side, Ok represents a length on the optical axis from the surface of the R lens unit closest to an image side to a rear principal point of the R lens unit, and Sk represents a back focus of the zoom lens.

Further features of the disclosure will become apparent from the following description of exemplary embodiments with reference to the attached drawings.

### BRIEF DESCRIPTION OF THE DRAWINGS

FIG. 1 is a lens cross-sectional view of a zoom lens according to Numerical Embodiment 1 in focusing on an object at infinity at wide angle end.

FIG. 2A shows aberration diagrams of the zoom lens according to Numerical Embodiment 1 in focusing on an object at infinity at a wide angle end.

FIG. 2B shows aberration diagrams of the zoom lens according to Numerical Embodiment 1 in focusing on an object at infinity at an intermediate zoom position.

FIG. 2C shows aberration diagrams of the zoom lens according to Numerical Embodiment 1 in focusing on an object at infinity at a telephoto end.

FIG. 3 is a lens cross-sectional view of a zoom lens according to Numerical Embodiment 2 in focusing on an object at infinity at wide angle end.

FIG. 4A shows aberration diagrams of the zoom lens according to Numerical Embodiment 2 in focusing on an object at infinity at a wide angle end.

FIG. 4B shows aberration diagrams of the zoom lens according to Numerical Embodiment 2 in focusing on an object at infinity at an intermediate zoom position.

FIG. 4C shows aberration diagrams of the zoom lens according to Numerical Embodiment 2 in focusing on an object at infinity at a telephoto end.

FIG. 5 is a lens cross-sectional view of a zoom lens according to Numerical Embodiment 3 in focusing on an object at infinity at wide angle end.

FIG. 6A shows aberration diagrams of the zoom lens according to Numerical Embodiment 3 in focusing on an object at infinity at a wide angle end.

FIG. 6B shows aberration diagrams of the zoom lens according to Numerical Embodiment 3 in focusing on an object at infinity at an intermediate zoom position.

FIG. 6C shows aberration diagrams of the zoom lens according to Numerical Embodiment 3 in focusing on an object at infinity at a telephoto end.

FIG. 7 is a lens cross-sectional view of a zoom lens according to Numerical Embodiment 4 in focusing on an object at infinity at wide angle end.

FIG. 8A shows aberration diagrams of the zoom lens according to Numerical Embodiment 4 in focusing on an object at infinity at a wide angle end.

FIG. 8B shows aberration diagrams of the zoom lens according to Numerical Embodiment 4 in focusing on an object at infinity at an intermediate zoom position.

FIG. 8C shows aberration diagrams of the zoom lens according to Numerical Embodiment 4 in focusing on an object at infinity at a telephoto end.

FIG. 9 is a lens cross-sectional view of a zoom lens according to Numerical Embodiment 5 in focusing on an object at infinity at wide angle end.

FIG. 10A shows aberration diagrams of the zoom lens according to Numerical Embodiment 5 in focusing on an object at infinity at a wide angle end.

FIG. 10B shows aberration diagrams of the zoom lens according to Numerical Embodiment 5 in focusing on an object at infinity at an intermediate zoom position.

FIG. 10C shows aberration diagrams of the zoom lens according to Numerical Embodiment 5 in focusing on an object at infinity at a telephoto end.

FIG. 11 is a schematic diagram of a main part of an image pickup apparatus of the disclosure.

FIG. 12 is an explanatory view showing a position of a principal point of the R-lens unit of the zoom lens of the disclosure.

### DESCRIPTION OF THE EMBODIMENTS

An exemplary embodiment of the disclosure will now be described in detail with reference to the accompanying drawings.

In order to achieve downsizing and weight reduction while securing a long back focus in the SHV-capable zoom lens, it is important to place a rear principal point to image side by configuring the power arrangement of a lens unit (hereinafter referred to as a relay lens unit) which is responsible for image forming action as a lens unit disposed at the most image side of a zoom lens in retro focus type. In a conventional zoom lens, there is also a type in which a beam emitted from a magnification lens unit reaches the relay lens unit with a strong divergent angle, and there are many configurations in the object side of the relay lens unit in which the diameter of the axial ray is suppressed small by a positive refractive power. Then, the rear principal point of the relay lens unit enters object side, so that the lens moves relatively toward the image plane side, making it difficult to secure a long back focus while achieving the small size and light weight of lens unit. In order to secure a long back focus, in the past, there was a limit in achieving downsizing and weight reduction of lenses because a positive power is provided in the object side of the relay lens unit and a lens unit having a strong negative power and a lens unit having were provided in the image side of the relay lens unit to secure a retrofocus configuration. A zoom type has been also known in a power arrangement of a super telephoto zoom lens and the like, in which a convergent beam is incident to a relay lens unit and a lens unit disposed in the object side of a relay lens unit is decentered to perform an optical image stabilization. However, there has been many types of zoom lenses in which since a sufficiently strong refractive power is assigned for image stabilizing function, sensitivity is high, the structure around the image stabilizing unit becomes complicated and the unit length of the relay lens unit becomes relatively long.

A zoom lens of the disclosure has a first lens unit having a positive refractive power, a second lens unit having a negative refractive power, an M lens unit having a positive refractive power, and an R lens unit having a positive refractive power serving as a last lens unit. The distance between the first lens unit and the image pickup plane is constant in zooming, and the second lens unit and the M lens unit are moved along an optical axis in zooming. An aperture stop is arranged in the image plane side of the second lens unit. The R lens unit has a lens subunit URn having a negative refractive power and a lens subunit URp having a positive refractive power. The zoom lens of the disclosure may have a lens unit in the R lens unit that is insertable into or removable from optical path to change a focal length of whole zoom lens system.

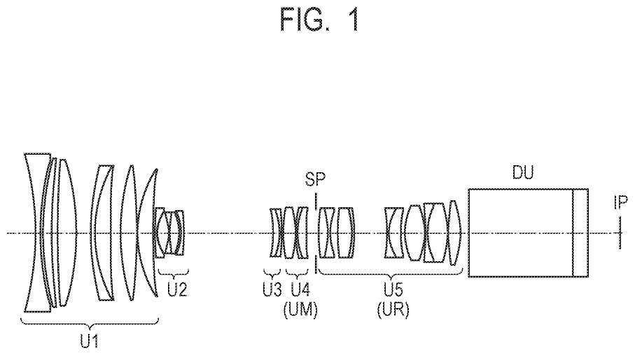

FIG. 1 is a cross-sectional diagram of a zoom lens of Embodiment 1 (Numerical Embodiment 1) when focus is at an object at infinity at wide angle end (focal length 16.3 mm).

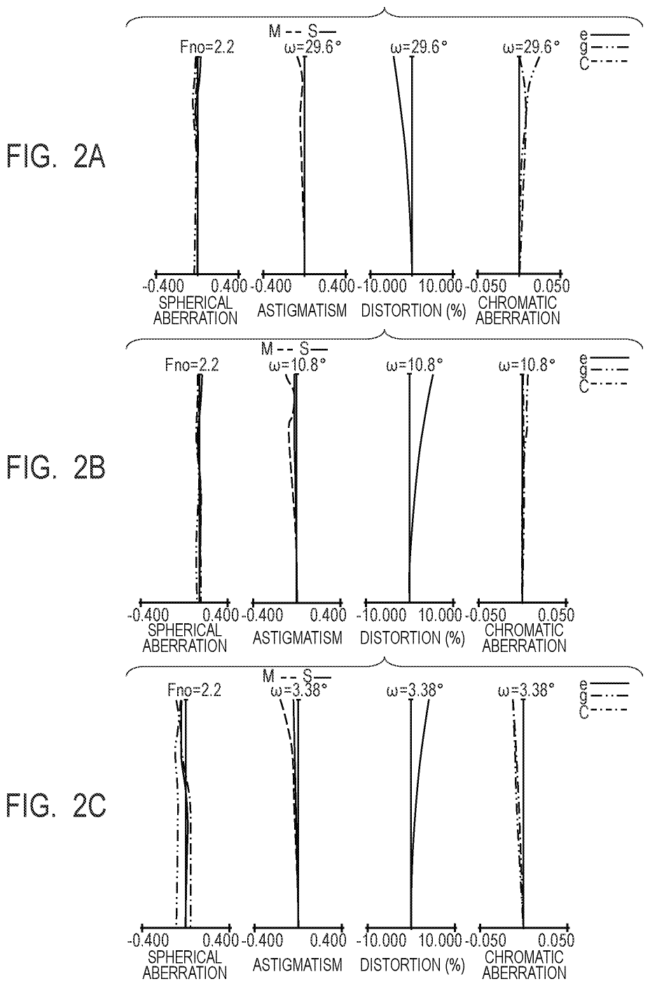

FIG. 2A shows aberration diagrams of the zoom lens according to Numerical Embodiment 1 in focusing on an object at infinity at wide angle end (focal length 16.3 mm).

FIG. 2B shows aberration diagrams of the zoom lens according to Numerical Embodiment 1 in focusing on an object at infinity at an intermediate zoom position (focal length 48.6 mm).

FIG. 2C shows aberration diagrams of the zoom lens according to Numerical Embodiment 1 in focusing on an object at infinity at a telephoto end (focal length 156.8 mm).

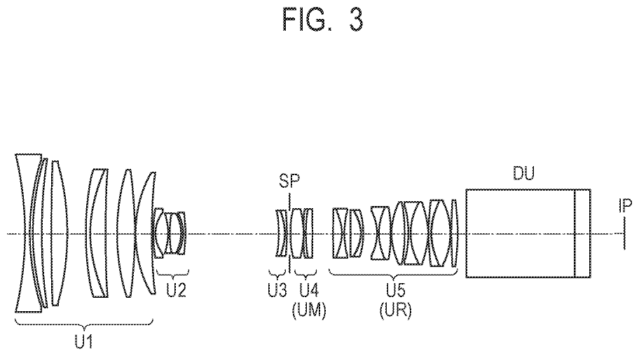

FIG. 3 is a lens cross-sectional view of a zoom lens according to Numerical Embodiment 2 in focusing on an object at infinity at wide angle end (focal length 16.3 mm).

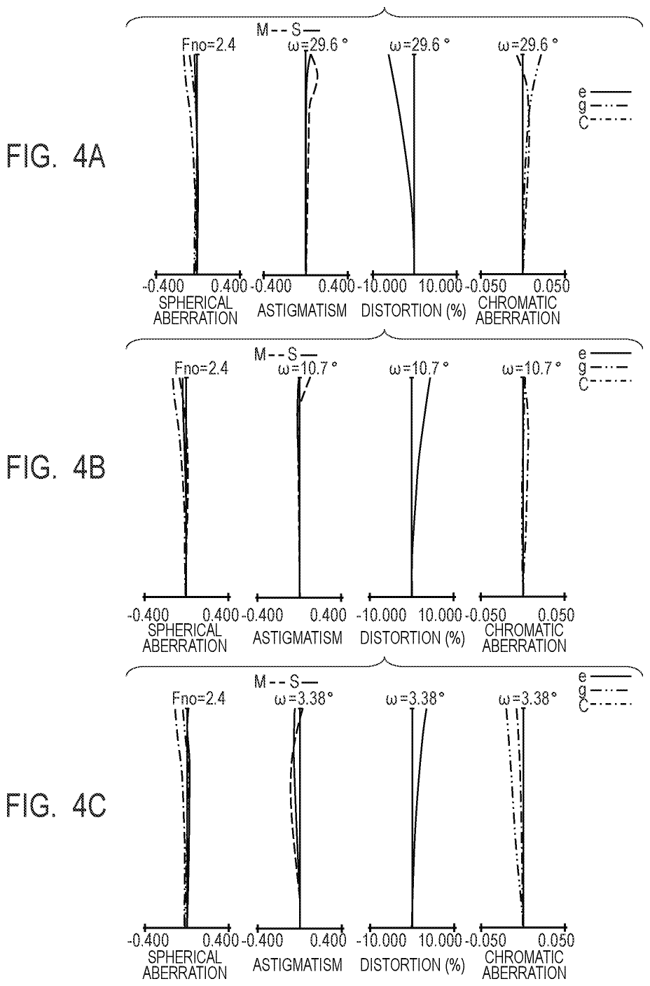

FIG. 4A shows aberration diagrams of the zoom lens according to Numerical Embodiment 2 in focusing on an object at infinity at a wide angle end (focal length 16.3 mm).

FIG. 4B shows aberration diagrams of the zoom lens according to Numerical Embodiment 2 in focusing on an object at infinity at an intermediate zoom position (focal length 49.0 mm).

FIG. 4C shows aberration diagrams of the zoom lens according to Numerical Embodiment 2 in focusing on an object at infinity at a telephoto end (focal length 156.8 mm).

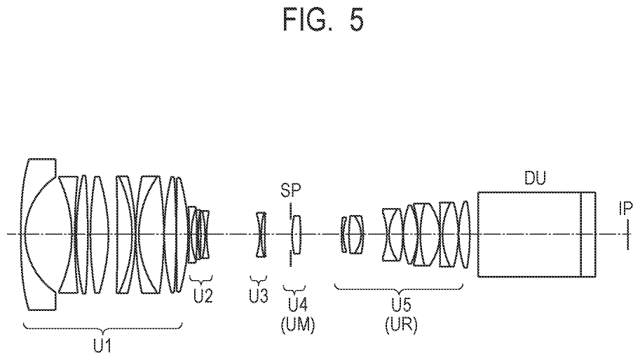

FIG. 5 a lens cross-sectional view of a zoom lens according to Numerical Embodiment 3 in focusing on an object at infinity at wide angle end (focal length 9.7 mm).

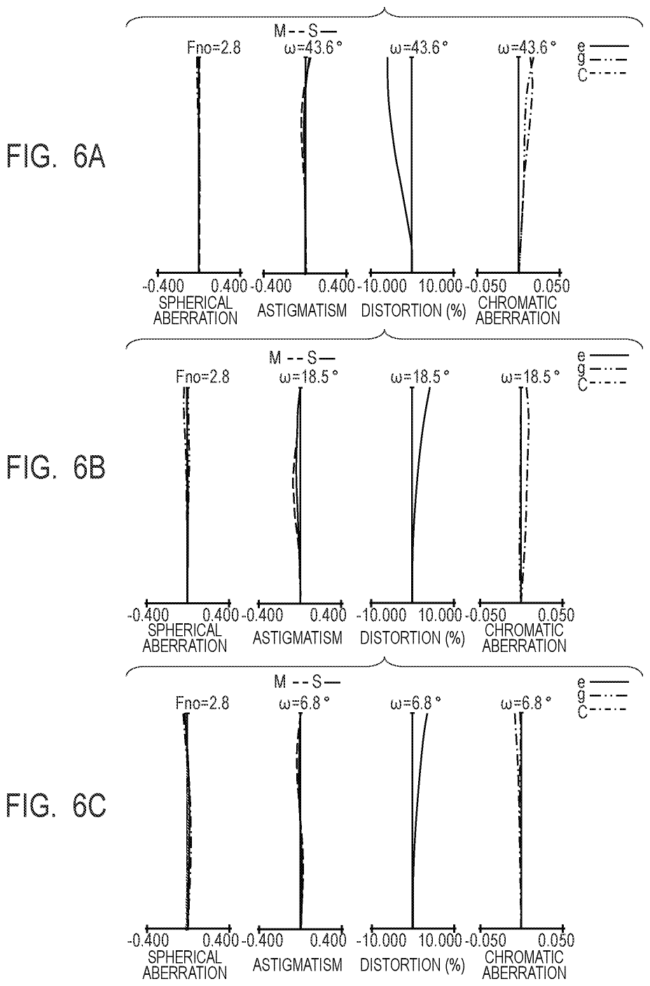

FIG. 6A shows aberration diagrams of the zoom lens according to Numerical Embodiment 3 in focusing on an object at infinity at a wide angle end (focal length 9.7 mm).

FIG. 6B shows aberration diagrams of the zoom lens according to Numerical Embodiment 3 in focusing on an object at infinity at an intermediate zoom position (focal length 27.7 mm).

FIG. 6C shows aberration diagrams of the zoom lens according to Numerical Embodiment 3 in focusing on an object at infinity at a telephoto end (focal length 77.6 mm).

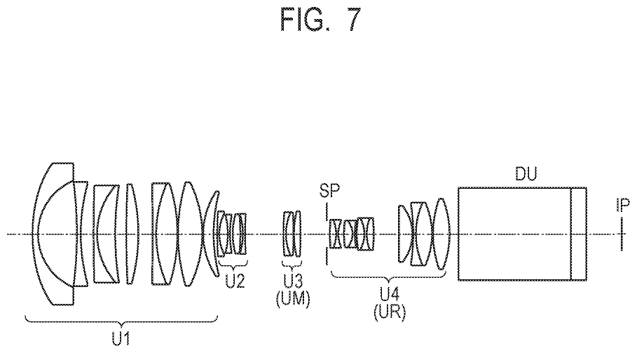

FIG. 7 is a lens cross-sectional view of a zoom lens according to Numerical Embodiment 4 in focusing on an object at infinity at wide angle end (focal length 9.0 mm).

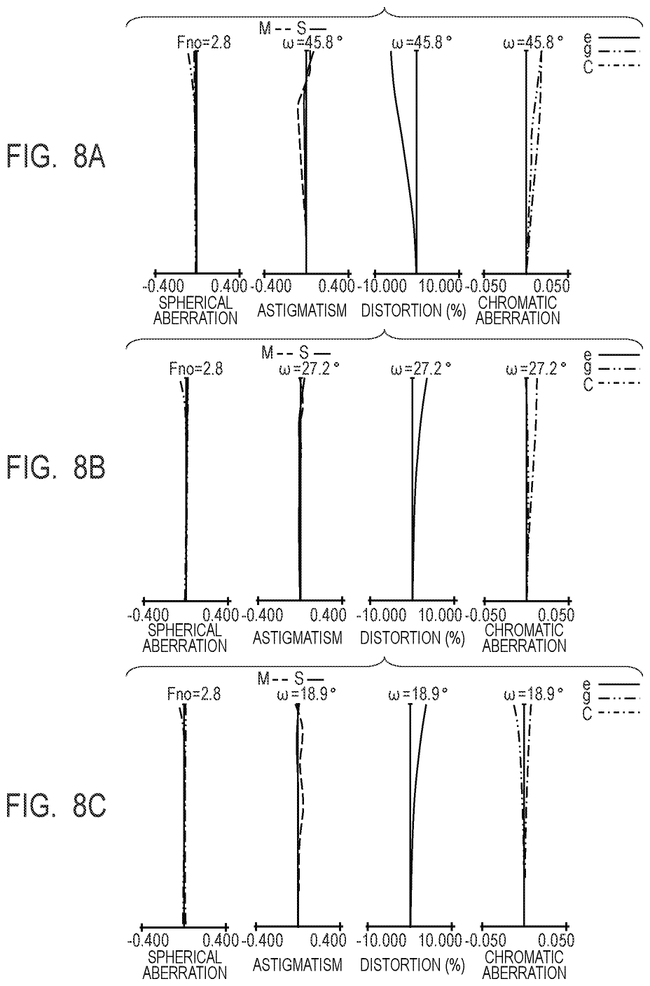

FIG. 8A shows aberration diagrams of the zoom lens according to Numerical Embodiment 4 in focusing on an object at infinity at a wide angle end (focal length 9.0 mm).

FIG. 8B shows aberration diagrams of the zoom lens according to Numerical Embodiment 4 in focusing on an object at infinity at an intermediate zoom position (focal length 18.0 mm).

FIG. 8C shows aberration diagrams of the zoom lens according to Numerical Embodiment 4 in focusing on an object at infinity at a telephoto end (focal length 27.0 mm).

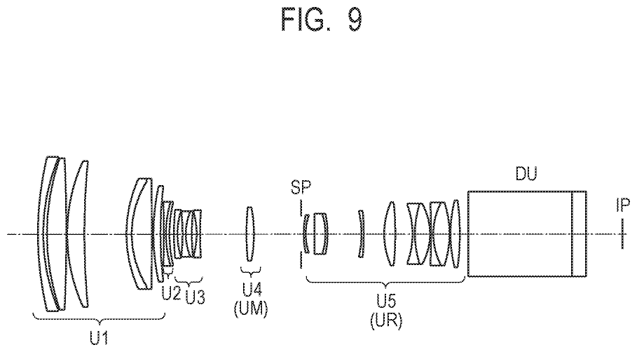

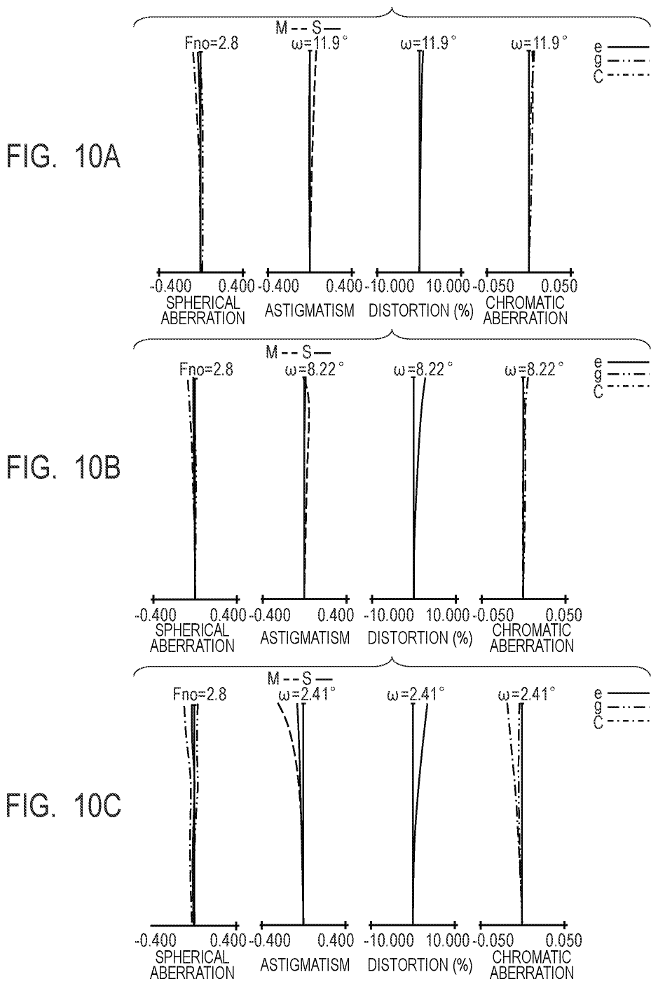

FIG. 9 is a lens cross-sectional view of a zoom lens according to Numerical Embodiment 5 in focusing on an object at infinity at wide angle end (focal length 44.0 mm). FIG. 10A shows aberration diagrams of the zoom lens according to Numerical Embodiment 5 in focusing on an object at infinity at a wide angle end (focal length 44.0 mm).

FIG. 10B shows aberration diagrams of the zoom lens according to Numerical Embodiment 5 in focusing on an object at infinity at an intermediate zoom position (focal length 98.6 mm).

FIG. 10C shows aberration diagrams of the zoom lens according to Numerical Embodiment 5 in focusing on an object at infinity at a telephoto end (focal length 220.0 mm).

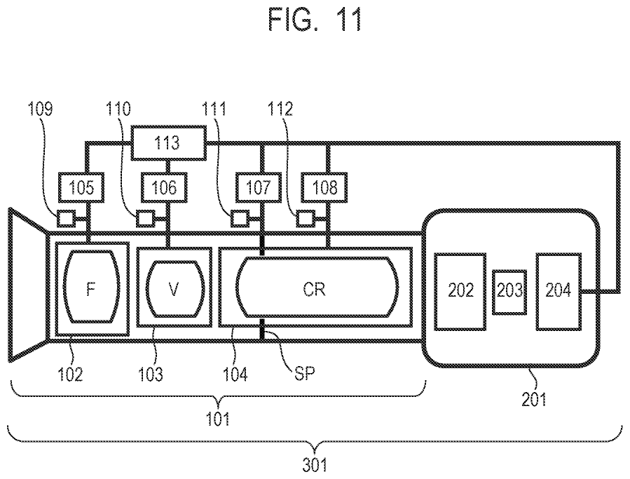

FIG. 11 is a schematic diagram of a main part of an image pickup apparatus of the disclosure.

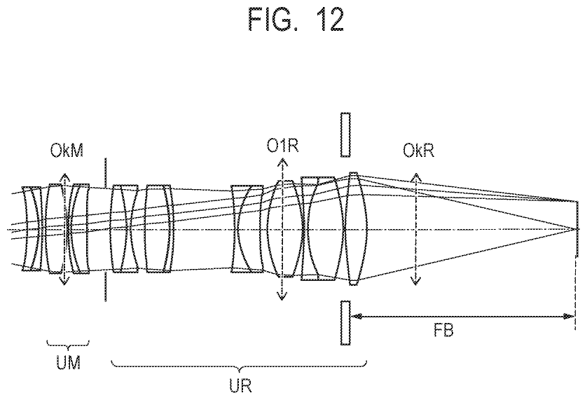

FIG. 12 is an explanatory view showing a position of a principal point of the R-lens unit of the zoom lens of the disclosure.

In each lens cross sectional diagram, the left side is object (object) side (front) and the right side is image side (rear). The definition of sign of distance is as follows: negative sign is assigned to a distance from a certain position to an object side direction, and positive is assigned to a distance from a certain position to an image side direction.

In the lens cross sectional diagram, U1 is the first lens unit having a positive refractive power including a focusing lens unit. U2 is the second lens unit having a negative refractive power including a magnification-changing lens unit, which is moved toward the image plane side along the optical axis to change magnification from wide angle end to telephoto end. UM is the M lens unit UM having a positive refractive power which is moved along the optical axis to change magnification from wide angle end to telephoto end. A magnification changing optical system is composed of the second lens unit U2 to the M lens unit UM. SP is a stop (aperture stop). In the disclosure, the aperture stop SP is appropriately arrange in the image side of the second lens unit U2. The stop SP may be moved along the optical axis when zooming. UR is the R lens unit which serves the image forming as the rear-most lens unit in the zoom lens of the disclosure. DU represents a color splitting prism, an optical filter, and the like, and is shown as a dummy glass block in the figure. IP corresponds to an image pickup plane of solid-state image pickup element (photoelectric conversion device) which receives an image formed by the zoom lens.

A zoom lens of each embodiment may include a lens unit (an extender lens unit) that is a part of optical member of the R lens unit that is insertable to and extractable from the optical path to change focal length range of entire system of zoom lens. In addition, by moving an optical member of a part of the R lens unit along the optical axis, it is possible to have function to adjust back focus. In the above-described zoom lens of each embodiment, a zoom type suitable for achieving a high magnification of zoom lens under a good optical performance is adopted.

A zoom lens of each embodiment includes a second lens unit U2 having a negative refractive power and configured to be moved for zooming and an M lens unit UM. The zoom lens easily achieves a high magnification and good optical performance by using a zoom type in which a plurality of lens units constitutes magnification lens units that move for changing magnification.

In longitudinal aberration drawing, spherical aberration is shown for e-line (solid line) and g-line (chain double-dotted line). Astigmatism is shown for e-line by meridional image plane (dotted line) and sagittal image plane (solid line). Chromatic aberration of magnification is shown for g-line (a chain double-dotted line). Fno stands for F-number and ω stands for shooting half angle of view. In longitudinal aberration drawing, spherical aberration is depicted at a scale of 0.4 mm, astigmatism at a scale of 0.4 mm, distortion at a scale of 10%, and chromatic aberration of magnification at a scale of 0.05 mm. In each of the following embodiments, wide angle end and telephoto end refer to zoom positions which respectively corresponds to the both mechanical ends in a range in which the second lens unit U2 for zooming can move in the optical axis direction.

Embodiment 1 of the zoom lens of the disclosure includes a first lens unit U1 having a positive refractive power, a second lens unit U2 having a negative refractive power, a third lens unit U3 having a negative refractive power, a fourth lens unit having a positive refractive power, and a fifth lens unit U5 having a positive refractive power. The M lens unit UM having a positive refractive power which moves for zooming corresponds to the fourth lens unit U4, and the R lens unit UR which is the rearest lens unit (a lens unit disposed on the most image side) corresponds to the fifth lens unit U5. Also, an aperture stop is arranged between the fourth lens unit U4 and the fifth lens unit U5, and does not move for zooming.

In the first embodiment, the following inequalities are satisfied,

0.65≤Sk/DR≤1.4 (1)

0.1≤Ok/Sk≤0.6 (2)

where DR represents the unit length of the fifth lens unit U5 corresponding to the R lens unit UR which is the rearest lens unit, Ok represents a distance from the vertex of the rearest lens surface of the fifth lens unit U5 to the rear principal point of the fifth lens unit U5, and Sk represents a back focus (in air) (also referred to as a back focus length (in air)).

Next, the technical meanings of the above-mentioned inequalities will be described.

The inequalities (1) and (2) are designed to secure a desired length of back focus while achieving miniaturization and weight reduction of zoom lens with high specifications and high performance. The disclosure defines a unit length of the R lens unit which is the rearest lens unit and a suitable range of the rear principal point position of the R lens unit relative to back focus length of the high specification zoom lens which is assumed in the disclosure.

The conditional expression (1) defines a ratio of the back focus length of the zoom lens assumed in the disclosure to the length of the R lens unit. With respect to an SHV-compatible zoom lens in which a long back focus is required, by satisfying the inequality (1), it is possible to realize a suitable length of the R lens unit while taking into consideration of restriction in mechanism of the SHV mount (Super Hi-Vision mount) in the length direction and an increase in the diameter of the R lens unit due to off-axis beam. If the upper limit of the inequality (1) is not satisfied, the unit length DR of the R lens unit becomes relatively short, and lens configuration in the R lens unit is excessively simplified, which makes it difficult to improve the performance of zoom lens and to secure various mechanical adjustment portions such as back focus adjusting mechanism. If the lower limit of the inequality (1) is not satisfied, the unit length DR of the R lens unit becomes relatively long, and effective diameter of the rearest lens is increased owing to an off-axial beam, and it becomes difficult to satisfy the diameter constraint of the SHV mount mechanism.

More preferably, the inequality (1) is set as follows.

0.68≤Sk/DR≤1.30 (1a)

More preferably, the inequality (1a) is set as follows.

0.73≤Sk/DR≤1.20 (1aa)

More preferably, the inequality (1aa) is set as follows.

0.80≤Sk/DR≤1.15 (1aaa)

Moreover, the inequality (2) defines a relation between a back focus length Sk of the zoom lens of the aspect of the embodiments and the distance Ok between a vertex of the rearest lens surface of the R lens unit UR of the zoom lens and the rear principal point position.

The effect of the R lens unit UR to position the object side principal point at more object side will be described with reference to FIG. 12. In FIG. 12, UM represents the M lens unit UM, UR represents the R lens unit UR, OkM represents the rear principal point position of the M lens unit UM, O1R represents the object side principal point position of the R lens unit UR, and OkR represents the rear principal point position of the R lens unit UR.

In the SHV zoom lens assumed by the aspect of the embodiments, a specified flange back length (FB in FIG. 12) is secured as an interface condition between an interchangeable lens and a camera. In order for holding mechanism of the R lens unit UR to mount together without interference with a camera mechanism, the rearest lens of the R lens unit UR cannot be positioned closer to the image plane side relative to the flange back length FB, and is to be in a certain realistic range. When a high specification is required for a zoom lens attachable to a large format sensor and an angle of view at the wide angle end becomes wider than a certain level, the lens diameter of the rearest lens of the R lens unit UR becomes determined by the height of off-axial beam. In order to satisfy the lens diameter restriction imposed by the SHV mount mechanism and the miniaturization and weight reduction of the lens, it is preferable to dispose the rearest lens of the R lens unit as relatively more objects side as possible to reduce the diameter of the rearest lens of the R lens unit UR. In order to realize this, it is effective for the rear principal point of the R lens unit to be disposed in the image plane side of the surface vertex of the rearest lens of the R lens unit UR and so that the thickness defining portion of the R lens unit is disposed relatively to the object side.

As described above, satisfying the inequality (2) causes a state in which the rear principal point of the R lens unit UR is disposed in sufficiently more image side, and therefore, it becomes easy to simultaneously secure a sufficient back focus length, wider angle of view, and compact and lightweight of a zoom lens. If the upper limit of inequality (2) is not satisfied, the retrofocus configuration in the R lens unit UR becomes excessively strong, it becomes difficult to enhance the performance of the zoom lens. If the lower limit of inequality (2) is not satisfied, the amount of the displacement of the rear principal point of the R lens unit UR to image side is insufficient, and it becomes difficult to suppress the unit length of the R lens unit UR and the diameter of the rearest lens of the R lens unit UR.

More preferably, the inequality (2) is set as follows.

0.11≤Ok/Sk≤0.55 (2a)

More preferably, the inequality (2a) is set as follows.

0.13≤Ok/Sk≤0.50 (2aa)

More preferably, the inequality (2aa) is set as follows.

0.15≤Ok/Sk≤0.45 (2aaa)

Further, in zoom lens of the aspect of the embodiments, it is to satisfy one or more of the following inequalities.

0.610≤θRn≤0.680 (3)

−1.0≤fRm<0 (4)

−3.5≤fRn/fR≤−0.8 (5)

1.5≤Sk/Ak≤2.4 (6)

−6.5≤f1/f2≤−1.0 (7)

−9.5≤ft/f2≤−1.2 (8)

where θRn represents a partial dispersion ratio of an optical material of a negative lens that is disposed most object side or a secondary most object side among negative lenses adopted in both a single lens and a cemented lens for the R lens unit in the zoom lens, f1 represents a focal length of the first lens unit U1, f2 represents a focal length of the second lens unit, fM represents a combined focal length of the M lens unit UM and a lens unit having a positive refractive power disposed adjacently to the object side of the M lens unit or disposed adjacently to the image side of the M lens unit, fR represents a focal length of the R lens unit UR, fRn represents a focal length of a lens subunit URn having a negative refractive power that is included as an object side part of the R lens unit UR and emits light divergently that is incident on the lens subunit URn convergently or afocally, ft represents a focal length of the zoom lens at telephoto end, and Ak represents an effective diameter of a lens disposed on the most image side in the R lens unit.

Note that the partial dispersion ratio θ is expressed by the following equation,

θ=(Ng−NF)/(NF−NC)

where Ng, NF, and NC represent refractive indeces of material for g-line (wavelength 435.8 nm), F-line (wavelength 486.1 nm), and for C-line (wavelength 656.3 nm), respectively.

The inequality (3) defines a range of the feature of the partial dispersion ratio satisfied by an optical material forming a negative lens disposed in the most object side or in the secondary most object side among negative lenses adopted in the R lens unit UR constituting the zoom lens of the aspect of the embodiments. It is sufficient that either one of the two negative lenses satisfies the inequality (3). In zoom lens of the aspect of the embodiments, among the lenses constituting the R lens unit UR, a material of the high dispersion characteristic is adopted in a lens disposed in the image side in which off-axial beam passes through a relatively high position to reduce chromatic aberration of magnification which is particularly conspicuous in wide angle end. Note that, if the above configuration is adopted, since axial chromatic aberration tends to be excessively corrected, and therefore, an optical material is adopted so as to keep correction balance of the axial chromatic aberration optimum in the lens unit included as an object side part of the R lens unit UR. This glass material selection need not necessarily be carried out in the negative lens included in the R lens unit UR at the most object side, but is preferrably carried out in a lens disposed at relatively object side through which the off axial beam passes near optical axis in the configuration of the R lens unit UR assumed by the zoom lens of the aspect of the embodiments.

By satisfying the inequality (3) to prevent the excessive correction of the axial chromatic aberration while reducing the chromatic aberration of magnification at wide angle end of the zoom lens, an optimal optical material of the R lens unit UR can be selected to achieve a zoom lens with high performance. If the upper limit of the inequality (3) is not satisfied, a material with an excessibely high in partial dispersion ratio is adopted for the lens having a negative refractive power in the R lens unit UR, and axial chromatic aberration of the whole zoom lens is becomes insufficiently corrected. If the lower limit of the inequality (3) is not satisfied, control to reduce the correction of the axial chromatic aberration by a lens disposed in the object side of the R lens unit becomes insufficient so that the axial chromatic aberration of the whole zoom lens becomes excessively corrected.

More preferably, the inequality (3) is set as follows.

0.615≤θRn≤0.675 (3a)

More preferably, the inequality (3a) is set as follows.

0.620≤θRn≤0.665 (3aa)

More preferably, the inequality (3aa) is set as follows.

0.630≤θRn≤0.660 (3aaa)

In addition, the inequality (4) defines a ratio of a combined focal length fM of the M lens unit constituting the zoom lens of the aspect of the embodiments and a lens unit having a positive refractive power disposed adjacent to and on the image side or on the object side of the M lens unit, to a focal length fRn of the lens subunit URn having a negative refractive power included in the R lens unit UR. Here, the lens subunit URn having a negative refractive power included in the R lens unit UR is defined as a lens subunit including at least one positive lens and at least one negative lens and the lens subunit being constituted by lenses from a lens disposed at the most object side in the R lens unit UR to a lens through which a beam incident on with a convergent or afocal inclination angle (collimated beam to optical axis) is emitted as a diverged beam with an increased divergence degree. In the disclosure, the beam incident on with an afocal inclination angle (collimated beam to optical axis) is defined as a case where a direction cosine value (shall take a negative sign for convergence and a positive sign for divergence) of an axial beam to an optical axis is in a range in ±0.03. The conversion into divergence of the angle of an axial beam of emission with respect to incidence is defined as a case where a direction cosine of the axial beam with respect to optical axis changes by an amount greater than 0.03. By satisfying the inequality (4), it is possible to set an optimal ratio of the focal lengths of the M lens unit UM to the lens subunit URn for achieving miniaturization and weight reduction while properly securing back focus length. The ratio does not exceed the upper limit in the inequality (4) die to the relationship of signs of the focal lengths. When the lower limit of the inequality (4) is not satisfied, since the lens subunit URn has a relatively strong negative power so that the retrofocus arrangement is strengthened, it becomes difficult to downsize the diameter of the lens disposed in the rear side of the R lens unit UR and to obtain an arrangement having a sufficient number of lenses for performance improvement.

More preferably, the inequality (4) is set as follows.

−0.9≤fM/fRn≤−0.1 (4a)

More preferably, the inequality (4a) is set as follows.

−0.85≤fM/fRn≤−0.2 (4aa)

More preferably, the inequality (4aa) is set as follows.

−0.7≤fM/fRn≤−0.3 (4aaa)

In addition, the inequality (5) defines a ratio of a focal length fRn of the lens subunit URn having the negative refractive power included in the R lens unit UR to the focal length fR of the R lens unit UR constituting the zoom lens of the aspect of the embodiments. By satisfying the inequality (5), it is possible to set a ratio of the focal length of the R lens unit UR and the focal length of the lens subunit URn that is an optimum for achieving miniaturization and weight reduction while properly securing back focus. If the upper limit of the inequality (5) is not satisfied, since the power of the lens subunit URn becomes relatively strong and the diameter of beam at a rear side lens unit in the R lens unit UR becomes high, so that the miniaturization and weight reduction of the R lens unit UR becomes difficult. If the lower limit of the inequality (5) is not satisfied, the power of the lens subunit URn becomes relatively weak and the effect of positioning the principal point in sufficiently more image side by the retrofocus arrangement is insufficient, and it becomes difficult to achieve both the securing of a long back focus, the miniaturization and weight reduction of the R lens unit UR.

More preferably, the inequality (5) is set as follows.

−3.0≤fRn/fR≤−0.9 (5a)

More preferably, the inequality (5a) is set as follows.

−2.5≤fRn/fR≤−1.0 (5aa)

More preferably, the inequality (5aa) is set as follows.

−2.0≤fRn/fR≤−1.2 (5aaa)

Also, the inequality (6) defines a ratio of the effective diameter Ak of the lens arranged at the most image side of the zoom lens of the aspect of the embodiments to a back focus length Sk. By satisfying the inequality (6), an appropriate range of the effective diameter of the lens for the zoom lens of the aspect of the embodiments is defined. If the upper limit of the inequality (6) is not satisfied, the effective diameter of the rearest lens becomes relatively low so that it becomes to sufficiently correct an off-axial aberration, and it becomes difficult to achieve both high specifications and high performance. If the lower limit of the inequality (6) is not satisfied, the effective diameter of the rearest lens becomes relatively high so that downsizing and weight reduction become difficult. In addition, an interference may be caused in the mount diameter restriction assumed by the aspect of the embodiments.

More preferably, the inequality (6) is set as follows.

1.6≤Sk/Ak≤2.2 (6a)

More preferably, the inequality (6a) is set as follows.

1.7≤Sk/Ak≤2.1 (6aa)

More preferably, the inequality (6aa) is set as follows.

1.8≤Sk/Ak≤2.0 (6aaa)

Also, the inequality (7) defines a ratio of the focal length f1 of the first lens unit of the zoom lens of the aspect of the embodiments to the focal length f2 of the second lens unit. By satisfying the inequality (7), it is possible to efficiently realize the high specification of zoom lens. If the upper limit of the inequality (7) is not satisfied, the magnification ratio owing to the second lens unit U2 is small so that it becomes difficult to realize a zoom lens of higher magnification and wider angle of view. If the lower limit of the inequality (7) is not satisfied, the power of the second lens unit U2 becomes relatively strong so that it becomes difficult to reduce the size and weight of the first lens unit U1 and to improve the performance over the entire zoom range.

More preferably, the inequality (7) is set as follows.

−6.0≤f1/f2≤5−1.2 (7a)

More preferably, the inequality (7a) is set as follows.

−5.5≤f1/f2≤−1.5 (7aa)

More preferably, the inequality (7aa) is set as follows.

−5.0≤f1/f2≤−2.0 (7aaa)

Also, the inequality (8) defines a ratio of a focal length ft at the telephoto end to the focal length f2 of the second lens unit of the zoom lens of the aspect of the embodiments. By satisfying the inequality (8), the zoom lens is provided with a power arrangement beneficial in achieving a high magnification. If the upper limit of the inequality (8) is not satisfied, magnification ratio owing to the second lens unit U2 is small so that it becomes difficult to obtain a zoom lens with higher in magnification and wider angle of view. If the lower limit of the inequality (8) is not satisfied, the power of the second lens unit U2 becomes relatively strong so that it becomes difficult to reduce the size and weight of the first lens unit U1 and to improve the performance of the entire zoom range.

More preferably, the inequality (8) is set as follows.

−9.0≤ft/f2≤−1.5 (8a)

More preferably, the inequality (8a) is set as follows.

−8.5≤ft/f2≤−2.0 (8aa)

More preferably, the inequality (8aa) is set as follows.

−8.0≤ft/f2≤−2.5 (8aaa)

In addition, the image pickup apparatus of the disclosure has a feature in including a zoom lens according to each embodiment and a solid-state image-pickup element that has a predetermined effective image pickup area to receive a light of an image formed by the zoom lens.

The specific configuration of the zoom lens of the disclosure is described below by feature of Numerical Embodiments 1-5 of the lens configuration corresponding to embodiments 1-5, respectively.

### Embodiment 1

FIG. 1 is a sectional view of a zoom lens according to Embodiment 1 (Numerical Embodiment 1) of the disclosure at a wide angle end (focal length: 16.3 mm). FIGS. 2A, 2B and 2C show longitudinal aberration diagrams of the zoom lens of Embodiment 1 at wide angle end (focal length: 16.3 mm), intermediate zoom position (focal length: 48.6 mm) and telephoto end (focal length: 156.8 mm), respectively. The sectional view of the zoom lens and the longitudinal aberration diagrams are depicted in a state of focusing at infinity. The value of focal length is the value of Numerical Embodiment in mm, which will be described later. The same is true in all of the following Numerical Embodiments.

In FIG. 1, the zoom lens of Embodiment 1 includes in order from the object side to the image side, a first lens unit U1 having a positive refractive power which does not move for zooming but moves for focusing; a second lens unit U2 having a negative refractive power which moves from the object side to the image side for zooming from the wide angle end to the telephoto end; a third lens unit U3 having a negative refractive power which moves along the optical axis for zooming; and a fourth lens unit U4 having a positive refractive power which moves along the optical axis for zooming. In the first embodiment, the second lens unit U2, the third lens unit U3 and the fourth lens unit U4 constitute a variable magnification system (zooming optical system). In addition, the zoom lens has a fifth lens unit U5 having a positive refractive power having an image forming action. An aperture stop SP is included between the fourth lens unit U4 and the fifth lens unit U5. DU represents a dummy lens on the assumption of camera optical system. IP is the image plane which corresponds to an image pickup surface such as a solid-state image-pickup element (photoelectric conversion device) which receives light of image formed by a zoom lens when the zoom lens is used as an image pickup optical system in camera for broadcast television, video camera, or digital still camera. When the zoom lens is used as an image pickup optical system of a film camera, the image plane corresponds to a film surface which is exposed to light of image formed by the zoom lens.

In longitudinal aberration diagrams, straight line and two-dot chain line in spherical aberration diagrams represent e line and g-line, respectively. Dotted lines and solid lines in astigmatism diagram represent meridional image plane and sagittal image plane, respectively. Two-dot chain line in chromatic aberration of magnification diagram represents g-line. ω represents half angle of view and Fno represents F-number. In longitudinal aberration diagrams, spherical aberration is depicted at 0.4 mm, astigmatism at 0.4 mm, distortion at 10%, and chromatic aberration of magnification at 0.05 mm in scale. In each of the following embodiments, wide angle end and telephoto end refer to zoom positions when the second lens unit U2 movable for zooming along the optical axis is positioned at both ends of the movable range, respectively.

Next, correspondence of Numerical Embodiment to surface data will be explained. The first lens unit U1 corresponds to the first surface to the thirteenth surface. The first surface to the fourth surface correspond to the 11 lens unit U11 having a negative refractive power which does not move for focusing. The fifth surface to the sixteenth surface corresponds to the 12 lens unit U12 having a positive refractive power which moves from the object side to the image side during focusing at from infinity to the closest object distance. The seventh surface to the ninth surface corresponds to the 13 lens unit U13 having a positive refractive power which does not move for focusing. The tenth surface to the thirteenth surface correspond to the 14 th lens unit U14 having a positive refractive power which moves from the image side to the object side for focusing at from infinity to the closest object distance. In Numerical Embodiment 1, the 12 lens unit U12 and the 14 lens unit U14 perform a so-called floating focus in which a plurality of lens units moves for focusing. The second lens unit U2 corresponds to the fourteenth surface to the twentieth surface. The third lens unit U3 corresponds to the twenty-first surface to the twenty-third surface. The fourth lens unit U4 corresponds to the twenty-fourth surface to the twenty-eighth surface. An aperture stop corresponds to the twenty-ninth surface. The aperture stop in Embodiment 1 does not move for zooming. The fifth lens unit U5 corresponds to the thirtieth surface to the fourth-fifth surface. The fourth-sixth surface to the forty-eighth surface represent dummy glass plate which corresponds to a color separating optical system and the like. In first embodiment, the M lens unit UM of claim 1 of the disclosure corresponds to the fourth lens unit U4, and the R lens unit UR as the rearest lens unit corresponds to the fifth lens unit U5.

Two negative lenses disposed at the most object side and the secondly most object side among lenses having a negative refractive power adopted in the fifth lens unit U5 of the first embodiment, correspond to the thirty-first surface to the thirty-second surface and the thirty-fourth surface to the thirty-fifth surface. Among them, partial dispersion characteristic of an optical material adopted in the negative lens from the thirty-fourth surface to the thirty-fifth surface satisfies the high partial dispersion ratio assumed in the disclosure, and is responsible for balance adjustment to favorably correct the chromatic aberration of magnification and the axial chromatic aberration in whole zoom lens system. In addition, the fifth lens unit U5 has a cemented lens corresponding to the thirtieth surface to the thirty-second surface having a negative refractive power constituted by a lens having a positive refractive power and a lens having a negative refractive power. Since the axial beam changes from a convergent beam to a divergent beam through the cemented lens, the cemented lens corresponds to the lens subunit URn having a negative refractive power included in the R lens unit UR defined in the disclosure.

Numerical Embodiment 1 corresponding to Embodiment 1 will be described. Not only in Numerical Embodiment 1 but also in all Numerical Embodiments, i represents an order of the surface (optical surface) counted from the object side, ri represents radius of curvature of the i-th surface counted from the object side, di represents the an interval between the i-th surface and the i+1-th surface counted from the object sice (on the optical axis). Further, ndi, vdi and θgFi represent refractive index, Abbe number and partial dispersion ratio of medium (optical member) between the i-th surface and the i+1-th surface. Sk represents back focus when the dummy lens length of an optical system of camera or a dividing prism optical system is convered in a length in air. The asterisk (*) on the right of the surface number indicates that the surface is an aspherical surface. Aspherical surface shape is expressed as the following formula, assuming X axis for the optical axis direction, H axis for a direction vertical to the optical axis, a positive sign for light's progression direction, R for paraxial radius of curvature, k for conic constant, and A4, A6, A8, A 10, A 12, A 14, and A 16 for aspherical surface coefficient. “e-Z” means “×10^{-Z}”.

$$X = \frac{{H}^{2} / R}{1 + \sqrt{1 - ( 1 + k ) {( H / R )}^{2}}} + A 4 {H}^{4} + A 6 {H}^{6} + A 8 {H}^{8} + A 10 {H}^{10} + A 12 {H}^{12} + A 14 {H}^{14} + A 16 {H}^{16}$$

Table 1 shows values for the conditional expressions of the present embodiment. Embodiment 1 satisfies the inequalities (1) to (8), and in particular, by appropriately setting lens configuration, refractive power, and glass material of the fifth lens unit, a zoom lens with wide view angle, high zoom ratio, small size and light weight and high optical performance over entire zoom range is obtained while ensuring a long back focus suitable for SHV mounting. In one embodiment, the zoom lens of the disclosure is used to satisfy the inequalities (1) and (2), but the inequalities (3) to (8) may not be satisfied. However, if at least one of the inequalities (3) to (8) is satisfied, an even better effect can be obtained. The same applies to all embodiments. In column (a) of Table 1, as to the lens subunit URn having a negative refractive power included in object side of the R lens unit UR, focal length fRn of the lens subunit URn, surfaces constituting the lens subunit URn, direction cosine value of an axial beam incident on the lens subunit URn from the object side, and direction cosine value of an axial beam exiting from the lens subunit URn toward the image side are described for reference. The sign of the direction cosine value in the disclosure is negative for a convergent beam and positive for a divergent beam.

FIG. 11 is a schematic diagram of an image pickup apparatus (television camera system) using the zoom lens of each Embodiment as an image pickup optical system. In FIG. 11, reference numeral 101 denotes a zoom lens according to first to fifth embodiments. Reference numeral 124 denotes a camera. A zoom lens 101 is mountable to the camera 124. Reference numeral 125 denotes an image pickup apparatus constituted by a camera 124 and a zoom lens 101 mounted on the camera 124. A zoom lens 101 has a first lens unit F, a magnification lens unit LZ, and an rear lens unit R for image forming. The first lens unit F includes a focus lens unit. The magnification lens unit LZ includes the second lens unit and the third lens unit that moves along the optical axis for zooming. Reference character SP represents an aperture stop. The rear lens unit R for image forming includes the R lens unit. Reference numerals 114 and 115 denote driving mechanisms, such as a helicoid and a cam, for driving the first lens unit F and the magnification varying lens unit LZ along the optical axis direction, respectively. Reference numerals 116 to 118 denote motors (drivers) for electrically driving the drive mechanisms 114 and 115 and the aperture stop SP. Reference numerals 119 to 121 denote detectors such as an encoder, an potentiometer and a photosensor for detecting positions on the optical axis of the first lens unit F and the magnification varying lens unit LZ, and stop diameter of the aperture stop SP. In camera 124, reference numeral 109 denotes a glass block corresponding to an optical filter or a color separating optical system in camera 124. Reference numeral 110 denotes a solid-state image-pickup element (a photoelectric conversion device) such as a CCD sensor or a CMOS sensor for receiving light of an object image formed by the zoom lens 101. Reference numerals 111 and 122 denote CPUs that control various drives of the camera 124 and the zoom lens 101.

As described above, by applying the zoom lens of the disclosure to the television camera, an image pickup apparatus having a high optical performance is realized.

### Embodiment 2

FIG. 3 is a lens cross sectional view of a zoom lens according to Embodiment 2 (Numerical Embodiment 2) of the disclosure at wide angle end (focal length 16.3 mm). FIGS. 4A, 4B, and 4C show longitudinal aberration diagrams of the zoom lens of Embodiment 2 at wide angle end (focal length 16.3 mm), intermediate zoom position (focal length 49.0 mm), and telephoto end (focal length 156.8 mm), respectively. The lens cross sectional view and the aberration diagrams are in a state of focusing at infinity.

In FIG. 3, the zoom lens of Embodiment 2 has in order from object side: a first lens unit U1 having a positive refractive power for focusing; a second lens unit U2 having a negative refractive power for magnification configured to move from object side to image side for zooming from wide angle end to telephoto end; a third lens unit U3 having a negative refractive power for magnification configured to move along the optical axis for zooming; a fourth lens unit U4 having a positive refractive power configured to move along the optical axis for zooming; and a fifth lens unit U5 having a positive refractive power for image forming. In Embodiment 2, the second lens unit U2, the third lens unit U3, and the fourth lens unit U4 constitute a variable magnification optical system. SP denotes an aperture stop, and is arranged between the fourth lens unit U4 and the fifth lens unit U5. DU represents a dummy lens on the assumption of a camera optical system. IP demotes an image plane.

Next, the correspondence of Numerical Embodiment 2 to the surface data will be described. The first lens unit U1 corresponds to the first surface to the thirteenth surface. The first surface to the fourth surface correspond to the 11 lens unit U11 having a negative refractive power configured not to move for focusing. The fifth surface to the sixth surface correspond to the 12 lens unit U12 having a positive refractive power configured to move from object side to image side for focusing at from infinity to the closest object distance. The seventh surface to the ninth surface correspond to the 13 lens unit U13 having a positive refractive power configured not to move for focusing. The tenth surface to the thirteenth surface correspond to the 14 lens unit U14 having a positive refractive power configured to move from image side to object side for focusing at from infinity to the closest object distance. In Numerical Embodiment 2, the 12 lens unit U12 and the 14 lens unit U14 perform a so-called floating focus in which both lens units move simultaneously for focusing. The second lens unit U2 corresponds to the fourteenth surface to the twentieth surface. The third lens unit U3 corresponds to the twenty-first surface to the twenty-third surface. The aperture stop corresponds to the twenty-fourth surface. The fourth lens unit U4 corresponds to the twenty-fifth surface to the twenty-ninth surface. In Embodiment 2, a structure is adopted in which the aperture stop moves along the optical axis together with the fourth lens unit U4 for zooming. The fifth lens unit U5 corresponds to the thirtieth surface to the fourth-eighth surface. The fourth-ninth surface to the fifty-first surface correspond to a dummy glass plate, which corresponds to a color separating optical system and the like. In Embodiment 2, the M lens unit UM according to claim 1 corresponds to the fourth lens unit U4, and the R lens unit UR as the rearest lens unit corresponds to the fifth lens unit U5. In addition, the lens subunit URn having a negative refractive power included in the R lens unit UR corresponds to the thirties the 30 surface to the thirty-eighth surface.

Table 1 shows values of the conditional expressions of Embodiment 2. Embodiment 2 satisfies the inequalities (1) to (8), and in particular, by appropriately setting the lens configuration, refractive power, and glass material of the fifth lens unit, to thereby achieve a zoom lens of wide view angle, small size, light weight, and high optical performance over the entire zoom range while ensuring a long back focus suitable for SHV mount.

### Embodiment 3

FIG. 5 is a cross sectional view of a zoom lens according to Embodiment 3 (Numerical Embodiment 3) of the disclosure at wide angle end (focal length 9.7 mm). FIGS. 6A, 6B and 6C show longitudinal aberration diagrams of the zoom lens according to Embodiment 3 at wide angle end (focal length 9.7 mm), intermediate zoom position (focal length 27.7 mm) and telephoto end (focal length 77.6 mm), respectively. The lens cross sectional view and the aberration diagrams are in a state of focusing at infinity.

In FIG. 5, the zoom lens of Embodiment 3 has in order from object side: a first lens unit U1 having a positive refractive power for focusing; a second lens unit U2 having a negative refractive power for magnification configured to move along the optical axis from object side to image side for zooming from wide angle end to telephoto end; a third lens unit U3 having a negative refractive power for zooming configured to move along the optical axis for zooming; a fourth lens unit U4 having a positive refractive power configured to move from object side to image side along the optical axis for zooming; and a fifth lens unit U5 having a positive refractive power for image forming. In Embodiment 3, the second lens unit U2, the third lens unit U3, and the fourth lens unit U4 constitute a variable magnification optical system. SP denotes an aperture stop arranged between the third lens unit U3 and the fourth lens unit U4, configured to move with the fourth lens unit U4 along the optical axis during zooming. DU denotes a dummy lens on the assumption of a camera optical system. IP denotes an image plane.

Next, correspondence of Numerical Embodiment 3 to the surface data will be described. The first lens unit U1 corresponds to the first surface to the eighteenth surface. The first surface to the sixth surface correspond to the 11 lens unit U11 having a negative refractive power configured not to move for focusing. The seventh surface to the eighth surface correspond to the 12 lens unit U12 having a positive refractive power configured to move from object side to image side for focusing at from infinity to the closest object distance. The ninth surface to the eighteenth surface correspond to the 13 lens unit U13 having a positive refractive power configured to move for focusing. In Numerical Embodiment 3, the 12 lens unit U12 and the 13 lens unit U13 perform a so-called floating focus in which the two lens units move simultaneously for focusing. The second lens unit U2 corresponds to the nineteenth surface to the twenty-fifth surface. The third lens unit U3 corresponds to the twenty-sixth surface to the twenty-eighth surface. An aperture stop corresponds to the twenty-ninth surface. The fourth lens unit U4 corresponds to the thirtieth surface to the thirty-first surface. In Embodiment 3, a structure is adopted in which the aperture stop moves along the optical axis during zooming together with the fourth lens unit U4. The fifth lens unit U5 corresponds to the thirty-second surface to the fourth-ninth surface. The fiftieth surface to the fifty-second surface correspond to a dummy glass plate, which corresponds to color separating optical system and the like. In Embodiment 3, the M lens unit UM in claim 1 corresponds to the fourth lens unit U4, and the R lens unit UR as the rearest lens unit corresponds to the fifth lens unit U5. In addition, the lens subunit URn having a negative refractive power included in the R lens unit UR corresponds to the thirty-second surface to the thirty-ninth surface.

Table 1 shows values of the conditional expressions for Embodiment 3. Embodiment 3 satisfies the inequalities (1) to (8), and in particular, by appropriately setting lens configuration, refractive power, and glass material of the fifth lens unit, to thereby achieve a zoom lens of wide view angle, small size, light weight, and high optical performance over the entire zoom range while ensuring a long back focus suitable for SHV mount.

### Embodiment 4

FIG. 7 is a cross sectional view of a zoom lens of Embodiment 4 (Numerical Embodiment 4) at wide angle end (focal length 9.0 mm) of the disclosure. FIGS. 8A, 8B and 8C show longitudinal aberration diagrams of the zoom lens of Embodiment 4 at wide angle end (fical length 9.0 mm), intermediate zoom position (focal length 18.0 mm) and telephoto end (focal length 27.0 mm), respectively. The lens cross sectional view and the aberration diagrams are in a state of focusing at infinity.

In FIG. 7, the zoom lens of Embodiment 4 has in order lens unit from object side: a first lens unit U1 having a positive refractive power having a positive refractive power for focusing; a second lens unit U2 having a negative refractive power for zooming and configured to move along the optical axis from object side to image side for zooming from wide angle end to telephoto end; a third lens unit U3 having a positive refractive power for zooming and configured to move along the optical axis for zooming; and a fourth lens unit U4 having a positive refractive power and having an image forming action. In Embodiment 4, the second lens unit U2 and the third lens unit U3 constitute a variable magnification optical system. SP denotes an aperture stop, that is arranged between the third lens unit U3 and the fourth lens unit U4, and is configured not to move for zooming. DU is a dummy lens on the assumption of a camera optical system. IP is an image plane. Next, correspondence of Numerical Embodiment 4 to the surface data will be described. The first lens unit U1 corresponds to the first surface to the sixteenth surface. The first surface to the seventh surface correspond to the 11 lens unit U11 having a negative refractive power and configured not to move for focusing. The eighth surface to the ninth surface correspond to the 12 lens unit U12 having a positive refractive power configured to move from object side to image side for focusing from infinity to the closest object distance. The tenth surface to the sixteenth surface correspond to the 13 lens unit U13 having a positive refractive power and configured not to move for focusing. The second lens unit U2 corresponds to the seventeenth surface to the twenty-fourth surface. The third lens unit U3 corresponds to the twenty-fifth surface to the twenty-ninth surface. An aperture stop corresponds to the thirtieth surface. The fourth lens unit U4 corresponds to the thirty-first surface to the fourth-seventh surface. In the fourth embodiment, the aperture stop does not move for zooming. The fourth-eighty surface to the fiftieth surface correspond to a dummy glass plate, which corresponds to a color separating optical system and the like. In Embodiment 4, the M lens unit UM of claim 1 of the disclosure corresponds to the third lens unit U3, and the R lens unit UR as the rearest lens unit corresponds to the fourth lens unit U4. In addition, the lens subunit URn having a negative refractive power included in the R lens unit UR corresponds to the thirty-first surface to the thirty-third surface.

Table 1 shows values of the conditional expressions of Embodiment 4. Embodiment 4 satisfies the inequalities (1) to (8), and in particular, by appropriately setting lens configuration, refractive power, and glass material of the fourth lens unit, to thereby achieve a zoom lens of wide view angle, small size, light weight, and high optical performance over the entire zoom range while securing a long back focus suitable for SHV mount.

### Embodiment 5

FIG. 9 is a view of a zoom lens of Embodiment 4 (Numerical Embodiment 4) of the disclosure at wide angle end (focal length 44.0 mm). FIGS. 10A, 10B, and 10C show longitudinal aberration diagrams of the zoom lens of Embodiment 5 at wide angle end (focal length 44.0 mm), intermediate zoom position (focal length 98.6 mm), and telephoto end (focal length 220.0 mm), respectively. The lens cross sectional view and the aberration diagrams are in a state of focusing at infinity.

In FIG. 9, the zoom lens of Embodiment 5 has in order from object side: a first lens unit U1 having a positive refractive power for focusing; a second lens unit U2 having a negative refractive power for zooming and configured to move along the optical axis from object side to image side for zooming from wide angle end to telephoto end; a third lens unit U3 having a negative refractive power for zooming and configured to move along the optical axis from object side to image side for zooming from wide angle end to telephoto end; a fourth lens unit U4 having a positive refractive power and configured to move along the optical axis for zooming; and a fifth lens unit U5 having a positive refractive power for image forming. In Embodiment 5, the second lens unit U2, the third lens unit U3, and the fourth lens unit U4 constitute a variable magnification optical system. SP demotes an aperture stop, arranged between the fourth lens unit U4 and the fifth lens unit U5, and configured not to move for zooming. DU denotes a dummy lens on the assumption of a camera optical system. IP denotes an image plane.

Next, correspondence of Numerical Embodiment 5 to the surface data will be described. The first lens unit U1 corresponds to the first surface to the eleventh surface. The first surface to the sixth surface correspond to the 11 lens unit U11 having a positive refractive power and configured which not to move for focusing. The seventh surface to the eleventh surface correspond to the 12 lens unit U12 having a positive refractive power and configured to move from image side to object side for focusing at from infinity to the closest object distance. The second lens unit U2 corresponds to the twelfth surface to the fourteenth surface. The third lens unit U3 corresponds to the fifteenth surface to the twenty-first surface. The fourth lens unit U4 corresponds to the twenty-second surface to the twenty-third surface. The aperture stop corresponds to the twenty-fourth surface. In Embodiment 5, a structure is adopted in which the aperture stop does not move for zooming. The fifth lens unit U5 corresponds to the twenty-fifth surface to the fourth-first surface. The fourth-second surface to the fourth-fourth surface correspond to a dummy glass plate, which corresponds to a color separating optical system and the like. In Embodiment 5, the M lens unit UM in claim 1 corresponds to the fourth lens unit U4, and the R lens unit UR as the rearest lens unit corresponds to the fifth lens unit U5. In addition, the lens subunit URn having a negative refractive power included in the R lens unit UR corresponds to the twenty-fifth surface to the thirty-first surface.

Table 1 shows values of the conditional expressions for Embodiment 5. Embodiment 5 satisfies the inequalities (1) to (8), and in particular, by appropriately setting lens configuration, refractive power, and glass material of the fifth lens unit, to thereby achieve a zoom lens of wide view angle, small size, light weight, and high optical performance over the entire zoom range while ensuring a long back focus suitable for SHV mount.

Although exemplary embodiments of the disclosure have been described above, the disclosure is not limited to these embodiments, and various range and modifications can be made within deformation in the spirit and scope thereof.

### Numerical Embodiment 1

Unit mm
Surface data

| Surface | | | | | | Effective | Focal |
|---|---|---|---|---|---|---|---|
| number | r | d | nd | vd | θgF | diameter | length |
| 1 | −167.13232 | 2.80000 | 1.749505 | 35.33 | 0.5818 | 88.827 | −104.771 |
| 2 | 151.08605 | 1.59677 | | | | 84.147 | |
| 3 | 154.01861 | 5.33115 | 1.959060 | 17.47 | 0.6598 | 83.969 | 292.268 |
| 4 | 330.70825 | 3.62180 | | | | 83.248 | |
| 5 | 594.57929 | 11.14451 | 1.603112 | 60.64 | 0.5415 | 82.227 | 186.151 |
| 6* | −138.09196 | 8.87620 | | | | 81.028 | |
| 7 | 154.48815 | 2.50000 | 1.846660 | 23.78 | 0.6205 | 77.887 | −202.140 |
| 8 | 80.96588 | 9.29853 | 1.438750 | 94.66 | 0.5340 | 76.331 | 218.458 |
| 9 | 496.35864 | 6.12189 | | | | 76.353 | |
| 10 | 126.60002 | 10.00578 | 1.433870 | 95.10 | 0.5373 | 77.361 | 198.665 |
| 11 | −265.68737 | 0.20000 | | | | 77.216 | |
| 12 | 67.44222 | 9.48829 | 1.595220 | 67.74 | 0.5442 | 72.853 | 139.474 |
| 13 | 335.46222 | (Variable) | | | | 72.354 | |
| 14 | 155.82298 | 0.95000 | 1.755000 | 52.32 | 0.5474 | 27.664 | −26.352 |
| 15 | 17.66769 | 7.55810 | | | | 23.012 | |
| 16 | −31.69279 | 0.75000 | 1.496999 | 81.54 | 0.5375 | 22.287 | −44.294 |
| 17 | 73.35231 | 5.79863 | 1.800000 | 29.84 | 0.6017 | 23.097 | 24.055 |
| 18 | −25.43887 | 0.93996 | | | | 23.491 | |
| 19 | −21.64494 | 1.20000 | 1.763850 | 48.49 | 0.5589 | 23.268 | −30.813 |
| 20* | −261.20188 | (Variable) | | | | 24.397 | |
| 21 | −67.68553 | 4.15111 | 1.808095 | 22.76 | 0.6307 | 24.796 | 72.034 |
| 22 | −32.33599 | 1.10000 | 1.905250 | 35.04 | 0.5848 | 25.654 | −46.252 |
| 23 | −141.10373 | (Variable) | | | | 26.745 | |
| 24* | 76.97248 | 7.28984 | 1.639999 | 60.08 | 0.5370 | 28.400 | 53.400 |
| 25 | −59.61422 | 0.19065 | | | | 29.111 | |
| 26 | 60.58535 | 1.10000 | 1.854780 | 24.80 | 0.6122 | 28.932 | −120.827 |
| 27 | 37.99653 | 5.40884 | 1.487490 | 70.23 | 0.5300 | 28.403 | 95.859 |
| 28 | 190.98280 | (Variable) | | | | 28.034 | |
| 29 (Stop) | ∞ | 1.49803 | | | | 27.135 | |
| 30 | 121.00334 | 5.61059 | 1.613397 | 44.27 | 0.5633 | 26.907 | 51.334 |
| 31 | −42.11619 | 1.20000 | 1.618000 | 63.33 | 0.5441 | 26.503 | −29.804 |
| 32 | 33.31496 | 4.67994 | | | | 25.639 | |
| 33 | 125.52972 | 8.41647 | 1.788800 | 28.43 | 0.6009 | 26.452 | 41.596 |
| 34 | −43.58882 | 1.30000 | 1.959060 | 17.47 | 0.6598 | 26.812 | −92.458 |
| 35 | −85.89637 | 20.00599 | | | | 27.083 | |
| 36 | −81.00487 | 1.30000 | 2.001000 | 29.14 | 0.5997 | 25.442 | −18.815 |
| 37 | 24.99847 | 7.39245 | 1.922860 | 18.90 | 0.6495 | 26.155 | 33.837 |
| 38 | 102.40290 | 2.13325 | | | | 26.952 | |
| 39* | 33.41032 | 11.71452 | 1.438750 | 94.66 | 0.5340 | 29.762 | 43.524 |
| 40 | −40.03316 | 0.49535 | | | | 30.402 | |
| 41 | −153.99258 | 1.40000 | 2.001000 | 29.14 | 0.5997 | 29.864 | −28.604 |
| 42 | 35.68603 | 12.00076 | 1.438750 | 94.66 | 0.5340 | 29.874 | 49.479 |
| 43 | −50.05347 | 0.50333 | | | | 32.978 | |
| 44 | 98.05628 | 7.29644 | 1.672700 | 32.10 | 0.5988 | 35.683 | 50.934 |
| 45 | −51.66396 | 4.99836 | | | | 36.067 | |
| 46 | ∞ | 63.04000 | 1.608590 | 46.44 | 0.5664 | 50.000 | |
| 47 | ∞ | 8.70000 | 1.516330 | 64.15 | 0.5352 | 50.000 | |
| 48 | ∞ | 19.89836 | | | | 50.000 | |

Image plane

Aspherical surface data

| | | | |
|---|---|---|---|
| Sixth surface | | | |
| K = −1.51267 e+001 | A4 = −6.49448 e-007 | A6 = 2.35413 e-010 | |
| A8 = −9.02147 e-014 | A10 = 2.62134 e-017 | A12 = −3.74536 e-021 | |
| Twentieth surface | | | |
| K = 3.72020 e+001 | A4 = −9.83020 e-006 | A6 = −4.95860 e-009 | |
| A8 = −2.35672 e-011 | A10 = 5.83243 e-014 | A12 = −2.06036 e-016 | |
| Twenty-fourth surface | | | |
| K = −1.45023 e+000 | A4 = −1.99598 e-006 | A6 = 6.26743 e-010 | A8 = 8.22589 e-013 |
| A10 = −4.34519 e-015 | A12 = 5.01150 e-018 | | |
| Thirty-ninth surface | | | |
| K = 0.00000 e+000 | A4 = −4.27684 e-006 | A6 = −7.94829 e-009 | A8 = 1.72183 e-010 |
| A10 = −1.52926 e-012 | A12 = 6.83842 e-015 | A14 = −1.54564 e-017 | |
| A16 = 1.39752 e-020 | | | |

Various data

| | |
|---|---|
| Zoom ratio | 9.62 |

| | | | |
|---|---|---|---|
| Focal length | 16.30 | 48.58 | 156.76 |
| F-number | 2.20 | 2.20 | 2.20 |
| Half angle of view | 29.57 | 10.78 | 3.38 |
| Total lens length | 326.15 | 326.15 | 326.15 |
| Sk (in air) | 69.74 | 69.74 | 69.74 |
| d 13 | 0.99 | 34.04 | 51.84 |
| d 20 | 54.15 | 4.53 | 2.01 |
| d 23 | 0.91 | 18.11 | 0.97 |
| d 28 | 5.99 | 5.35 | 7.22 |
| Entrance pupil position | 72.12 | 185.95 | 476.89 |
| Exit pupil position | 318.06 | 318.06 | 318.06 |
| Front principal point position | 89.49 | 244.03 | 732.60 |
| Rear principal point position | 53.44 | 21.16 | −87.02 |

Zoom lens unit data

| | | | | | Front | Rear |
|---|---|---|---|---|---|---|
| | | | | | principal | principal |
| | Leading | Focal | Lens | | point | point |
| Unit | surface | length | length | structure | position | position |
| 1 | 1 | 80.63 | 70.98 | | 44.72 | −1.59 |
| 2 | 14 | −18.55 | 17.20 | | 2.71 | −9.78 |
| 3 | 21 | −119.24 | 5.25 | | −1.41 | −4.32 |
| 4 | 24 | 47.73 | 13.99 | | 1.96 | −6.86 |
| 5 | 29 | 55.90 | 86.95 | | 69.14 | 26.14 |

Single lens element data

| | Leading | Focal |
|---|---|---|
| Lens | surface | length |
| 1 | 1 | −104.77 |
| 2 | 3 | 292.27 |
| 3 | 5 | 186.15 |
| 4 | 7 | −202.14 |
| 5 | 8 | 218.46 |
| 6 | 10 | 198.67 |
| 7 | 12 | 139.47 |
| 8 | 14 | −26.35 |
| 9 | 16 | −44.29 |
| 10 | 17 | 24.06 |
| 11 | 19 | −30.81 |
| 12 | 21 | 72.03 |
| 13 | 22 | −46.25 |
| 14 | 24 | 53.40 |
| 15 | 26 | −120.83 |
| 16 | 27 | 95.86 |
| 17 | 30 | 51.33 |
| 18 | 31 | −29.80 |
| 19 | 33 | 41.60 |
| 20 | 34 | −92.46 |
| 21 | 36 | −18.81 |
| 22 | 37 | 33.84 |
| 23 | 39 | 43.52 |
| 24 | 41 | −28.60 |
| 25 | 42 | 49.48 |
| 26 | 44 | 50.93 |

### Numerical Embodiment 2

Unit mm
Surface data

| Surface | | | | | | Effective | Focal |
|---|---|---|---|---|---|---|---|
| number | r | d | nd | vd | θgF | diameter | length |
| 1 | −187.34760 | 2.80000 | 1.749505 | 35.33 | 0.5818 | 88.023 | −107.077 |
| 2 | 142.96567 | 1.81242 | | | | 82.976 | |
| 3 | 145.78560 | 5.08914 | 1.959060 | 17.47 | 0.6598 | 82.694 | 296.506 |
| 4 | 289.97743 | 5.71212 | | | | 81.938 | |
| 5 | 1169.20294 | 9.58239 | 1.603112 | 60.64 | 0.5415 | 80.315 | 211.870 |
| 6* | −143.64819 | 10.44174 | | | | 79.248 | |
| 7 | 168.49773 | 2.50000 | 1.846660 | 23.78 | 0.6205 | 72.230 | −216.746 |
| 8 | 87.65240 | 9.02708 | 1.438750 | 94.66 | 0.5340 | 71.199 | 231.430 |
| 9 | 611.01826 | 6.72074 | | | | 71.291 | |
| 10 | 130.68204 | 10.23282 | 1.433870 | 95.10 | 0.5373 | 72.420 | 201.316 |
| 11 | −259.09528 | 0.20000 | | | | 72.156 | |
| 12 | 71.70856 | 9.62572 | 1.595220 | 67.74 | 0.5442 | 68.997 | 152.849 |
| 13 | 317.41519 | (Variable) | | | | 67.535 | |
| 14 | 150.88747 | 0.95000 | 1.755000 | 52.32 | 0.5474 | 26.617 | −28.632 |
| 15 | 18.93201 | 7.60525 | | | | 22.665 | |
| 16 | −32.68846 | 0.75000 | 1.496999 | 81.54 | 0.5375 | 21.437 | −46.098 |
| 17 | 77.93971 | 6.52518 | 1.800000 | 29.84 | 0.6017 | 21.331 | 25.743 |
| 18 | −27.23537 | 1.21261 | | | | 21.884 | |
| 19 | −22.74888 | 1.00000 | 1.763850 | 48.49 | 0.5589 | 21.524 | −32.488 |
| 20* | −264.15633 | (Variable) | | | | 22.281 | |
| 21 | −68.87046 | 4.20855 | 1.808095 | 22.76 | 0.6307 | 22.843 | 71.658 |
| 22 | −32.50154 | 1.00000 | 1.905250 | 35.04 | 0.5848 | 23.699 | −46.021 |
| 23 | −146.51296 | (Variable) | | | | 24.559 | |
| 24 (Stop) | ∞ | 0.89557 | | | | 25.251 | |
| 25* | 71.56910 | 7.34886 | 1.595220 | 67.74 | 0.5442 | 26.169 | 55.933 |
| 26 | −60.25431 | 0.18000 | | | | 26.892 | |
| 27 | 307.27308 | 1.10000 | 1.854780 | 24.80 | 0.6122 | 26.838 | −151.569 |
| 28 | 91.58825 | 3.98863 | 1.487490 | 70.23 | 0.5300 | 26.740 | 160.510 |
| 29 | −542.09458 | (Variable) | | | | 26.755 | |
| 30 | −338.33729 | 5.02046 | 1.738000 | 32.33 | 0.5900 | 26.541 | 40.982 |
| 31 | −28.12602 | 1.20000 | 1.496999 | 81.54 | 0.5375 | 26.589 | −36.491 |
| 32 | 52.21323 | 3.46557 | | | | 25.664 | |
| 33 | 273.94760 | 6.20991 | 1.613397 | 44.27 | 0.5633 | 25.720 | 34.695 |
| 34 | −23.00818 | 1.30000 | 1.959060 | 17.47 | 0.6598 | 25.680 | −53.163 |
| 35 | −42.63442 | 8.09977 | | | | 26.366 | |
| 36 | −28.32343 | 1.30000 | 2.001000 | 29.14 | 0.5997 | 24.916 | −15.682 |
| 37 | 36.68638 | 6.67972 | 1.922860 | 18.90 | 0.6495 | 28.535 | 26.936 |
| 38 | −73.09403 | 0.46860 | | | | 29.874 | |
| 39 | 39.89977 | 7.46560 | 1.761821 | 26.52 | 0.6136 | 34.436 | 37.355 |
| 40 | −94.05993 | 2.16889 | | | | 34.347 | |
| 41 | −70.14302 | 1.40000 | 2.001000 | 29.14 | 0.5997 | 33.707 | −23.353 |
| 42 | 35.84482 | 10.16097 | 1.595220 | 67.74 | 0.5442 | 34.236 | 34.992 |
| 43 | −44.82067 | 0.41632 | | | | 35.111 | |
| 44 | 175.98147 | 1.40000 | 2.001000 | 29.14 | 0.5997 | 35.751 | −53.571 |
| 45 | 41.19028 | 11.16427 | 1.438750 | 94.66 | 0.5340 | 35.580 | 48.037 |
| 46 | −39.79188 | 0.39373 | | | | 36.506 | |
| 47 | 295.60935 | 3.78014 | 1.761821 | 26.52 | 0.6136 | 36.807 | 119.989 |
| 48 | −133.29394 | 4.97957 | | | | 36.763 | |
| 49 | ∞ | 63.04000 | 1.608590 | 46.44 | 0.5664 | 50.000 | |
| 50 | ∞ | 8.70000 | 1.516330 | 64.15 | 0.5352 | 50.000 | |
| 51 | ∞ | 19.87957 | | | | 50.000 | |

Image plane

Aspherical surface data

| | | |
|---|---|---|
| Sixth surface | | |
| K = −1.38433 e+001 | A4 = −5.43792 e-007 | A6 = 1.69049 e-010 |
| A8 = −6.26109 e-014 | A10 = 1.88611 e-017 | A12 = −2.80918 e-021 |
| Twentieth surface | | |
| K = −1.16037 e+003 | A4 = −1.59352 e-005 | A6 = 4.37497 e-008 |
| A8 = −2.59520 e-010 | A10 = 8.02872 e-013 | A12 = −1.14954 e-015 |
| Twenty-fifth surface | | |
| K = −1.35953 e+000 | A4 = −2.53573 e-006 | A6 = 1.02275 e-009 |
| A8 = −1.41297 e-013 | A10 = −1.81339 e-015 | A12 = 2.38517e-018 |

Various data

| | |
|---|---|
| Zoom ratio | 9.62 |

| | | | |
|---|---|---|---|
| Focal length | 16.30 | 49.02 | 156.76 |
| F-number | 2.40 | 2.40 | 2.40 |
| Half angle of view | 29.57 | 10.69 | 3.38 |
| Total lens length | 320.88 | 320.88 | 320.88 |
| Sk (in air) | 69.70 | 69.70 | 69.70 |
| d 13 | 0.99 | 38.28 | 58.36 |
| d 20 | 54.43 | 3.42 | 2.42 |
| d 23 | 0.97 | 18.57 | 1.00 |
| d 29 | 12.18 | 8.30 | 6.79 |
| Entrance pupil position | 72.32 | 182.02 | 394.89 |
| Exit pupil position | 451.96 | 673.75 | 850.44 |
| Front principal point position | 89.31 | 235.02 | 583.13 |
| Rear principal point position | 53.40 | 20.68 | −87.06 |

Zoom lens unit data

| | | | | | Front | Rear |
|---|---|---|---|---|---|---|
| | | | | | principal | principal |
| | Leading | Focal | Lens | | point | point |
| Unit | surface | length | length | structure | position | position |
| 1 | 1 | 86.85 | 73.74 | | 48.87 | 0.78 |
| 2 | 14 | −19.60 | 18.04 | | 3.03 | −9.91 |
| 3 | 21 | −118.82 | 5.21 | | −1.30 | −4.19 |
| 4 | 24 | 57.07 | 13.51 | | 3.43 | −5.62 |
| 5 | 30 | 63.21 | 72.09 | | 52.29 | 9.20 |

Single lens element data

| | Leading | Focal |
|---|---|---|
| Lens | surface | length |
| 1 | 1 | −107.08 |
| 2 | 3 | 296.51 |
| 3 | 5 | 211.87 |
| 4 | 7 | −216.75 |
| 5 | 8 | 231.43 |
| 6 | 10 | 201.32 |
| 7 | 12 | 152.85 |
| 8 | 14 | −28.63 |
| 9 | 16 | −46.10 |
| 10 | 17 | 25.74 |
| 11 | 19 | −32.49 |
| 12 | 21 | 71.66 |
| 13 | 22 | −46.02 |
| 14 | 25 | 55.93 |
| 15 | 27 | −151.57 |
| 16 | 28 | 160.51 |
| 17 | 30 | 40.98 |
| 18 | 31 | −36.49 |
| 19 | 33 | 34.70 |
| 20 | 34 | −53.16 |
| 21 | 36 | −15.68 |
| 22 | 37 | 26.94 |
| 23 | 39 | 37.36 |
| 24 | 41 | −23.35 |
| 25 | 42 | 34.99 |
| 26 | 44 | −53.57 |
| 27 | 45 | 48.04 |
| 28 | 47 | 119.99 |

### Numerical Embodiment 3

Unit mm
Surface data

| Surface | | | | | | Effective | Focal |
|---|---|---|---|---|---|---|---|
| number | r | d | nd | vd | θgF | diameter | length |
| 1* | 462.09184 | 2.58020 | 1.800999 | 34.97 | 0.5864 | 88.734 | −57.991 |
| 2 | 42.36129 | 28.69152 | | | | 68.914 | |
| 3 | −78.43267 | 1.64503 | 1.639999 | 60.08 | 0.5370 | 67.606 | −98.677 |
| 4 | 333.61093 | 1.02899 | | | | 69.236 | |
| 5 | 167.12726 | 7.10248 | 1.959060 | 17.47 | 0.6598 | 70.378 | 126.601 |
| 6 | −456.68237 | 1.49620 | | | | 70.329 | |
| 7 | 220.65608 | 11.18108 | 1.537750 | 74.70 | 0.5392 | 69.207 | 127.579 |
| 8* | −98.24655 | 5.36616 | | | | 68.656 | |
| 9 | −1260.55289 | 9.06019 | 1.487490 | 70.23 | 0.5300 | 68.491 | 177.347 |
| 10 | −81.35479 | 2.00000 | 1.850250 | 30.05 | 0.5979 | 68.505 | −245.952 |
| 11 | −134.00196 | 0.19869 | | | | 69.713 | |
| 12 | 169.18837 | 1.84300 | 1.846660 | 23.78 | 0.6205 | 69.729 | −111.163 |
| 13 | 60.55318 | 15.33737 | 1.438750 | 94.66 | 0.5340 | 68.063 | 110.875 |
| 14 | −231.20829 | 0.18430 | | | | 68.392 | |
| 15 | 144.05228 | 7.40804 | 1.537750 | 74.70 | 0.5392 | 68.891 | 205.486 |
| 16 | −472.32928 | 0.18430 | | | | 68.643 | |
| 17 | 2168.34969 | 7.07519 | 1.763850 | 48.49 | 0.5589 | 68.177 | 150.716 |
| 18 | −122.03667 | (Variable) | | | | 67.841 | |
| 19* | −230.31435 | 1.19795 | 1.595220 | 67.74 | 0.5442 | 32.876 | −62.274 |
| 20 | 44.44840 | 3.43368 | | | | 29.379 | |
| 21 | −441.53246 | 0.82935 | 1.595220 | 67.74 | 0.5442 | 28.731 | −126.173 |
| 22 | 90.94040 | 1.66413 | | | | 27.641 | |
| 23 | −229.86841 | 2.67086 | 1.854780 | 24.80 | 0.6122 | 27.515 | 85.523 |
| 24 | −56.16417 | 0.82935 | 1.595220 | 67.74 | 0.5442 | 27.126 | −52.128 |
| 25 | 70.26166 | (Variable) | | | | 25.612 | |
| 26 | −42.35039 | 0.82935 | 1.804000 | 46.53 | 0.5577 | 23.888 | −28.581 |
| 27 | 51.24961 | 2.24652 | 1.892860 | 20.36 | 0.6393 | 25.255 | 72.968 |
| 28 | 225.72730 | (Variable) | | | | 25.549 | |
| 29 (Stop) | ∞ | 0.92150 | | | | 18.775 | |
| 30* | 49.88176 | 5.21650 | 1.696797 | 55.53 | 0.5434 | 33.406 | 51.918 |
| 31 | −127.99103 | (Variable) | | | | 33.593 | |
| 32 | 70.97317 | 1.20000 | 1.959060 | 17.47 | 0.6598 | 19.882 | −52.635 |
| 33 | 29.48042 | 3.44432 | | | | 19.602 | |
| 34 | 86.35917 | 7.37567 | 1.672700 | 32.10 | 0.5988 | 20.698 | 22.198 |
| 35 | −17.58647 | 1.30000 | 1.618000 | 63.33 | 0.5441 | 21.230 | −41.195 |
| 36 | −57.99984 | 14.47429 | | | | 21.696 | |
| 37 | −38.42008 | 1.30000 | 1.882997 | 40.76 | 0.5667 | 25.222 | −17.447 |
| 38 | 26.38318 | 8.54294 | 1.761821 | 26.52 | 0.6136 | 28.784 | 25.526 |
| 39 | −65.75520 | 0.20000 | | | | 30.332 | |
| 40 | 50.40375 | 8.82761 | 1.548141 | 45.79 | 0.5686 | 33.949 | 42.104 |
| 41 | −40.30641 | 0.20000 | | | | 34.289 | |
| 42 | −61.33729 | 1.40000 | 2.001000 | 29.14 | 0.5997 | 33.849 | −32.073 |
| 43 | 69.30648 | 11.96612 | 1.438750 | 94.66 | 0.5340 | 34.795 | 50.065 |
| 44 | −30.57499 | 0.20000 | | | | 36.451 | |
| 45 | −878.27963 | 1.40000 | 1.834810 | 42.74 | 0.5648 | 36.593 | −47.229 |
| 46 | 41.55059 | 9.73271 | 1.438750 | 94.66 | 0.5340 | 36.779 | 59.864 |
| 47 | −66.74702 | 0.20000 | | | | 37.685 | |
| 48 | 61.22793 | 6.86800 | 1.487490 | 70.23 | 0.5300 | 39.043 | 82.424 |
| 49 | −113.70262 | 4.99641 | | | | 38.893 | |
| 50 | ∞ | 63.04000 | 1.608590 | 46.44 | 0.5664 | 50.000 | |
| 51 | ∞ | 8.70000 | 1.516330 | 64.15 | 0.5352 | 50.000 | |
| 52 | ∞ | 19.89641 | | | | 50.000 | |

Image plane

Aspherical surface data

| | | | |
|---|---|---|---|
| First surface | | | |
| K = 0.00000 e+000 | A4 = 5.24769 e-007 | A6 = 2.35380 e-010 | A8 = −1.85666 e-013 |
| A10 = 6.17119 e-017 | A12 = −8.21780 e-021 | | |
| Eighth surface | | | |
| K = 0.00000 e+000 | A4 = 6.10331 e-007 | A6 = −1.49850 e-011 | A8 = 4.84677 e-014 |
| A10 = −6.88074 e-017 | A12 = 2.18402 e-020 | | |
| No. 19 surface | | | |
| K = 0.00000e+000 | A4 = 2.13155 e-006 | A6 = −4.06850 e-009 | A8 = 9.20467 e-012 |
| A10 = −1.88863 e-014 | A12 = 1.82968 e-017 | | |
| No. 30 surface | | | |
| K = 0.00000 e+000 | A4 = −3.98145 e-006 | A6 = 1.84633 e-009 | A8 = −1.62747 e-012 |

Various data

| | |
|---|---|
| Zoom ratio | 8.00 |

| | | | |
|---|---|---|---|
| Focal length | 9.70 | 27.67 | 77.60 |
| F-number | 2.80 | 2.80 | 2.80 |
| Half angle of view | 43.64 | 18.48 | 6.80 |
| Total lens length | 344.61 | 344.61 | 344.61 |
| Sk (in air) | 69.74 | 69.74 | 69.74 |
| d 18 | 0.69 | 41.54 | 63.05 |
| d 25 | 32.55 | 5.41 | 6.85 |
| d 28 | 15.77 | 16.08 | 2.22 |
| d 31 | 25.02 | 10.99 | 1.90 |
| Entrance pupil position | 43.90 | 75.31 | 132.79 |
| Exit pupil position | 172.16 | 277.20 | 655.45 |
| Front principal point position | 54.52 | 106.68 | 20.67 |
| Rear principal point position | 60.04 | 42.06 | −7.86 |

Zoom lens unit data

| | | | | | Front | Rear |
|---|---|---|---|---|---|---|
| | | | | | principal | principal |
| | Leading | Focal | Lens | | point | point |
| Unit | surface | length | length | structure | position | position |
| 1 | 1 | 52.08 | 102.38 | | 59.99 | 46.05 |
| 2 | 19 | −30.23 | 10.63 | | 3.21 | −4.84 |
| 3 | 26 | −46.89 | 3.08 | | 0.27 | −1.36 |
| 4 | 29 | 51.92 | 6.14 | | 1.79 | −2.24 |
| 5 | 32 | 54.66 | 78.63 | | 53.74 | 11.48 |

Single lens element Data

| | Leading | Focal |
|---|---|---|
| Lens | surface | length |
| 1 | 1 | −57.99 |
| 2 | 3 | −98.68 |
| 3 | 5 | 126.60 |
| 4 | 7 | 127.58 |
| 5 | 9 | 177.35 |
| 6 | 10 | −245.95 |
| 7 | 12 | −111.16 |
| 8 | 13 | 110.87 |
| 9 | 15 | 205.49 |
| 10 | 17 | 150.72 |
| 11 | 19 | −62.27 |
| 12 | 21 | −126.17 |
| 13 | 23 | 85.52 |
| 14 | 24 | −52.13 |
| 15 | 26 | −28.58 |
| 16 | 27 | 72.97 |
| 17 | 30 | 51.92 |
| 18 | 32 | −52.64 |
| 19 | 34 | 22.20 |
| 20 | 35 | −41.19 |
| 21 | 37 | −17.45 |
| 22 | 38 | 25.53 |
| 23 | 40 | 42.10 |
| 24 | 42 | −32.07 |
| 25 | 43 | 50.07 |
| 26 | 45 | −47.23 |
| 27 | 46 | 59.86 |
| 28 | 48 | 82.42 |

### Numerical Embodiment 4

Unit mm
Surface data

| Surface | | | | | | Effective | Focal |
|---|---|---|---|---|---|---|---|
| number | r | d | nd | vd | θgF | diameter | length |
| 1* | 94.01569 | 3.00000 | 1.772499 | 49.60 | 0.5520 | 77.416 | −64.097 |
| 2 | 32.08149 | 22.00000 | | | | 58.011 | |
| 3 | −207.77558 | 2.00000 | 1.603001 | 65.44 | 0.5401 | 56.619 | −111.778 |
| 4 | 100.67023 | 7.21946 | | | | 53.815 | |
| 5 | 817.07836 | 2.00000 | 1.772499 | 49.60 | 0.5520 | 52.784 | −54.284 |
| 6 | 40.02651 | 10.08909 | 1.805181 | 25.42 | 0.6161 | 52.214 | 62.909 |
| 7 | 163.57064 | 6.32372 | | | | 52.102 | |
| 8 | 559.20079 | 6.80390 | 1.487490 | 70.23 | 0.5300 | 53.467 | 176.087 |
| 9 | −101.40751 | 7.90856 | | | | 53.946 | |
| 10 | −2809.53668 | 2.00000 | 1.846660 | 23.78 | 0.6205 | 54.131 | −78.102 |
| 11 | 68.42903 | 12.08338 | 1.496999 | 81.54 | 0.5375 | 54.267 | 79.502 |
| 12 | −88.62346 | 0.20000 | | | | 54.842 | |
| 13 | 99.15962 | 13.71608 | 1.496999 | 81.54 | 0.5375 | 56.295 | 79.528 |
| 14 | −63.00426 | 0.40000 | | | | 56.032 | |
| 15 | 41.69430 | 5.86717 | 1.589130 | 61.14 | 0.5407 | 45.970 | 127.480 |
| 16 | 88.39957 | (Variable) | | | | 44.309 | |
| 17 | 144.26656 | 1.20000 | 1.804000 | 46.58 | 0.5573 | 23.753 | −36.258 |
| 18 | 24.26361 | 4.83826 | | | | 21.154 | |
| 19 | −40.33718 | 1.20000 | 1.487490 | 70.23 | 0.5300 | 20.359 | −49.702 |
| 20 | 61.79067 | 1.52410 | | | | 19.786 | |
| 21 | 40.37278 | 4.34628 | 1.846660 | 23.78 | 0.6205 | 20.693 | 33.327 |
| 22 | −92.05632 | 1.34578 | | | | 20.643 | |
| 23 | −36.54169 | 1.20000 | 1.804000 | 46.58 | 0.5573 | 20.537 | −35.691 |
| 24 | 138.88755 | (Variable) | | | | 20.948 | |
| 25 | 146.27770 | 1.40000 | 1.903660 | 31.32 | 0.5946 | 22.024 | −39.950 |
| 26 | 28.99740 | 4.29574 | 1.589130 | 61.14 | 0.5407 | 22.418 | 41.600 |
| 27 | −153.41661 | 0.20000 | | | | 22.946 | |
| 28 | 53.39657 | 3.72996 | 1.772499 | 49.60 | 0.5520 | 23.803 | 53.948 |
| 29 | −188.14701 | (Variable) | | | | 23.871 | |
| 30 (Stop) | ∞ | 1.84823 | | | | 14.675 | |
| 31 | 428.15514 | 3.43579 | 1.738000 | 32.33 | 0.5900 | 14.621 | 25.092 |
| 32 | −19.43605 | 1.20000 | 1.438750 | 94.66 | 0.5340 | 14.561 | −20.663 |
| 33 | 17.39442 | 3.22095 | | | | 13.703 | |
| 34 | 60.00030 | 4.79603 | 1.805181 | 25.42 | 0.6161 | 13.847 | 11.923 |
| 35 | −11.14120 | 1.30000 | 1.963000 | 24.11 | 0.6212 | 13.708 | −8.796 |
| 36 | 38.93307 | 0.98380 | | | | 13.982 | |
| 37 | 40.30317 | 4.34617 | 1.698947 | 30.13 | 0.6030 | 14.493 | 17.567 |
| 38 | −17.06174 | 1.30000 | 2.001000 | 29.14 | 0.5997 | 14.759 | −9.551 |
| 39 | 23.00044 | 3.91708 | 1.922860 | 18.90 | 0.6495 | 15.871 | 20.043 |
| 40 | −92.47864 | 14.16136 | | | | 16.580 | |
| 41 | 7662.22846 | 7.61125 | 1.438750 | 94.66 | 0.5340 | 28.643 | 55.891 |
| 42 | −24.65566 | 0.48090 | | | | 30.021 | |
| 43 | −102.05050 | 1.40000 | 2.001000 | 29.14 | 0.5997 | 30.744 | −29.114 |
| 44 | 41.54213 | 9.14080 | 1.496999 | 81.54 | 0.5375 | 32.101 | 43.143 |
| 45 | −41.32146 | 0.49478 | | | | 33.658 | |
| 46 | 56.59304 | 9.35488 | 1.517417 | 52.43 | 0.5564 | 37.760 | 53.801 |
| 47 | −52.15254 | 4.99520 | | | | 38.004 | |
| 48 | ∞ | 63.04000 | 1.608590 | 46.44 | 0.5664 | 50.000 | |
| 49 | ∞ | 8.70000 | 1.516330 | 64.15 | 0.5352 | 50.000 | |
| 50 | ∞ | 19.89520 | | | | 50.000 | |

Image plane

Aspherical surface data

| | | | |
|---|---|---|---|
| First surface | | | |
| K = 0.00000 e+000 | A4 = 1.07564 e-006 | A6 = −4.49925 e-011 | A8 = −2.37866 e-017 |
| A10 = 2.77096 e-017 | A12 = −4.33307 e-021 | | |

Various data

| | |
|---|---|
| Zoom ratio | 3.00 |

| | | | |
|---|---|---|---|
| Focal length | 9.00 | 18.00 | 27.00 |
| F-number | 2.80 | 2.80 | 2.80 |
| Half angle of view | 45.78 | 27.20 | 18.91 |
| Total lens length | 303.87 | 303.87 | 303.87 |
| Sk (in air) | 69.73 | 69.73 | 69.73 |
| d 16 | 2.00 | 24.44 | 31.42 |
| d 24 | 21.58 | 11.69 | 2.02 |
| d 29 | 14.68 | 2.12 | 4.81 |
| Entrance pupil position | 38.65 | 49.53 | 55.90 |
| Exit pupil position | 241.52 | 241.52 | 241.52 |
| Front principal point position | 48.12 | 69.42 | 87.15 |
| Rear principal point position | 60.73 | 51.73 | 42.73 |

Zoom lens unit data

| | | | | | Front | Rear |
|---|---|---|---|---|---|---|
| | | | | | principal | principal |
| | Leading | Focal | Lens | | point | point |
| Unit | surface | length | length | structure | position | position |
| 1 | 1 | 29.00 | 101.61 | | 50.54 | 41.13 |
| 2 | 17 | −20.40 | 15.65 | | 4.08 | −6.95 |
| 3 | 25 | 56.00 | 9.63 | | 4.57 | −1.16 |
| 4 | 30 | 39.75 | 68.99 | | 49.13 | 33.29 |

Single lens element data

| | Leading | Focal |
|---|---|---|
| Lens | surface | length |
| 1 | 1 | −64.10 |
| 2 | 3 | −111.78 |
| 3 | 5 | −54.28 |
| 4 | 6 | 62.91 |
| 5 | 8 | 176.09 |
| 6 | 10 | −78.10 |
| 7 | 11 | 79.50 |
| 8 | 13 | 79.53 |
| 9 | 15 | 127.48 |
| 10 | 17 | −36.26 |
| 11 | 19 | −49.70 |
| 12 | 21 | 33.33 |
| 13 | 23 | −35.69 |
| 14 | 25 | −39.95 |
| 15 | 26 | 41.60 |
| 16 | 28 | 53.95 |
| 17 | 31 | 25.09 |
| 18 | 32 | −20.66 |
| 19 | 34 | 11.92 |
| 20 | 35 | −8.80 |
| 21 | 37 | 17.57 |
| 22 | 38 | −9.55 |
| 23 | 39 | 20.04 |
| 24 | 41 | 55.89 |
| 25 | 43 | −29.11 |
| 26 | 44 | 43.14 |
| 27 | 46 | 53.80 |

### Numerical Embodiment 5

Unit mm
Surface data

| Surface | | | | | | Effective | Focal |
|---|---|---|---|---|---|---|---|
| number | r | d | nd | vd | θgF | diameter | length |
| 1 | 194.62794 | 3.20000 | 1.804000 | 46.53 | 0.5577 | 90.011 | −375.777 |
| 2 | 117.73753 | 2.30440 | | | | 88.174 | |
| 3 | 137.38405 | 11.91193 | 1.496999 | 81.54 | 0.5375 | 88.312 | 238.912 |
| 4 | −868.37074 | 0.39886 | | | | 87.833 | |
| 5 | 104.89364 | 10.41332 | 1.496999 | 81.54 | 0.5375 | 85.125 | 275.315 |
| 6 | 430.42837 | 25.57692 | | | | 83.552 | |
| 7 | 78.63914 | 3.20000 | 1.905250 | 35.04 | 0.5848 | 65.233 | −282.023 |
| 8 | 59.04744 | 12.26219 | 1.438750 | 94.66 | 0.5340 | 61.659 | 133.024 |
| 9 | −6036.22611 | 1.00000 | | | | 59.718 | |
| 10 | 131.50767 | 4.25214 | 1.438750 | 94.66 | 0.5340 | 56.325 | 722.371 |
| 11 | 222.15549 | (Variable) | | | | 54.350 | |
| 12* | −992.49993 | 1.30000 | 1.755000 | 52.32 | 0.5474 | 37.359 | −83.512 |
| 13 | 67.69483 | 2.03409 | 1.959060 | 17.47 | 0.6598 | 35.760 | 638.040 |
| 14 | 74.86511 | (Variable) | | | | 35.027 | |
| 15 | 145.27667 | 2.07864 | 1.772499 | 49.60 | 0.5520 | 27.932 | −81.848 |
| 16 | 43.92493 | 3.21975 | | | | 26.112 | |
| 17 | −114.15288 | 1.91874 | 1.589130 | 61.14 | 0.5407 | 25.877 | −45.055 |
| 18 | 34.97824 | 3.67583 | 1.846660 | 23.78 | 0.6205 | 26.142 | 54.875 |
| 19 | 130.77203 | 2.93588 | | | | 26.020 | |
| 20 | -47.97430 | 2.07864 | 1.696797 | 55.53 | 0.5434 | 26.042 | −55.067 |
| 21 | 199.35586 | (Variable) | | | | 27.154 | |
| 22* | 163.08876 | 4.64073 | 1.763850 | 48.49 | 0.5589 | 30.480 | 69.628 |
| 23 | −78.51700 | (Variable) | | | | 30.867 | |
| 24 (Stop) | ∞ | 1.49839 | | | | 21.443 | |
| 25 | 56.91655 | 1.20000 | 1.717362 | 29.52 | 0.6047 | 21.497 | −127.700 |
| 26 | 34.90078 | 5.40771 | | | | 21.225 | |
| 27 | −360.17357 | 6.62635 | 1.620041 | 36.26 | 0.5879 | 21.972 | 64.903 |
| 28 | −36.66788 | 1.30000 | 1.922860 | 18.90 | 0.6495 | 22.728 | −128.305 |
| 29 | −53.73163 | 20.65299 | | | | 23.152 | |
| 30 | −56.66927 | 1.30000 | 2.001000 | 29.14 | 0.5997 | 25.760 | −89.308 |
| 31 | −154.42498 | 12.37432 | | | | 26.614 | |
| 32 | 46.23254 | 6.87876 | 1.846660 | 23.78 | 0.6205 | 36.935 | 42.931 |
| 33 | −165.95141 | 10.45981 | | | | 36.725 | |
| 34 | −49.17803 | 1.40000 | 2.001000 | 29.14 | 0.5997 | 33.336 | −26.389 |
| 35 | 58.90847 | 9.23831 | 1.595220 | 67.74 | 0.5442 | 34.532 | 39.359 |
| 36 | −36.82941 | 0.49757 | | | | 35.365 | |
| 37 | −571.79262 | 1.40000 | 2.001000 | 29.14 | 0.5997 | 35.328 | −37.071 |
| 38 | 40.07669 | 9.94982 | 1.438750 | 94.66 | 0.5340 | 35.485 | 55.733 |
| 39 | −58.34227 | 0.49663 | | | | 36.804 | |
| 40 | 79.42607 | 5.80543 | 1.805181 | 25.42 | 0.6161 | 39.057 | 63.092 |
| 41 | −139.89826 | 4.99931 | | | | 39.005 | |
| 42 | ∞ | 63.04000 | 1.608590 | 46.44 | 0.5664 | 50.000 | |
| 43 | ∞ | 8.70000 | 1.516330 | 64.15 | 0.5352 | 50.000 | |
| 44 | ∞ | 21.99931 | | | | 50.000 | |

Image plane

Aspherical surface data

| | | | |
|---|---|---|---|
| Twelfth surface | | | |
| K = −2.00000 e+000 | A4 = 2.22968 e-007 | A6 = −4.90511 e-010 | A8 = 3.25217 e-012 |
| A10 = −9.24442 e-015 | A12 = 9.96456 e-018 | A14 = 4.24561 e-021 | |
| A16 = −1.18571 e-023 | | | |
| Twenty-second surface | | | |
| K = 2.82398 e+001 | A4 = −1.31031 e-006 | A6 = −2.06376 e-010 | |
| A8 = −7.82964 e-013 | | | |

Various data

| | |
|---|---|
| Zoom ratio | 5.00 |

| | | | |
|---|---|---|---|
| Focal length | 44.00 | 98.61 | 220.00 |
| F-number | 2.80 | 2.80 | 2.80 |
| Half angle of view | 11.87 | 5.36 | 2.41 |
| Total lens length | 328.51 | 328.51 | 328.51 |
| Sk (in air) | 71.84 | 71.84 | 71.84 |
| d 11 | 2.06 | 22.23 | 23.87 |
| d 14 | 2.82 | 11.22 | 35.43 |
| d 21 | 28.20 | 18.42 | 1.35 |
| d 23 | 28.70 | 9.91 | 1.14 |
| Entrance pupil position | 169.94 | 401.11 | 705.17 |
| Exit pupil position | 396.47 | 396.47 | 396.47 |
| Front principal point position | 219.90 | 529.68 | 1074.27 |
| Rear principal point position | 27.84 | −26.77 | −148.16 |

Zoom lens unit data

| | | | | | Front | Rear |
|---|---|---|---|---|---|---|
| | | | | | principal | principal |
| | Leading | Focal | Lens | | point | point |
| Unit | surface | length | length | structure | position | position |
| 1 | 1 | 106.79 | 74.52 | | 28.55 | −34.09 |
| 2 | 12 | −94.64 | 3.33 | | 1.95 | 0.18 |
| 3 | 15 | −26.96 | 15.91 | | 6.78 | −4.38 |
| 4 | 22 | 69.63 | 4.64 | | 1.79 | −0.86 |
| 5 | 24 | 60.66 | 96.49 | | 71.86 | 7.36 |

Single lens element data

| | Leading | Focal |
|---|---|---|
| Lens | surface | length |
| 1 | 1 | −375.78 |
| 2 | 3 | 238.91 |
| 3 | 5 | 275.32 |
| 4 | 7 | −282.02 |
| 5 | 8 | 133.02 |
| 6 | 10 | 722.37 |
| 7 | 12 | −83.51 |
| 8 | 13 | 638.04 |
| 9 | 15 | −81.85 |
| 10 | 17 | −45.05 |
| 11 | 18 | 54.87 |
| 12 | 20 | −55.07 |
| 13 | 22 | 69.63 |
| 14 | 25 | −127.70 |
| 15 | 27 | 64.90 |
| 16 | 28 | −128.30 |
| 17 | 30 | −89.31 |
| 18 | 32 | 42.93 |
| 19 | 34 | −26.39 |
| 20 | 35 | 39.36 |
| 21 | 37 | −37.07 |
| 22 | 38 | 55.73 |
| 23 | 40 | 63.09 |

TABLE 11
Conditional Expression

| | | Embodiment | | | | |
|---|---|---|---|---|---|---|
| | Condition | 1 | 2 | 3 | 4 | 5 |
| (1) | Sk/DR | 0.802 | 0.967 | 0.887 | 1.011 | 0.745 |
| (2) | Ok/Sk | 0.375 | 0.132 | 0.165 | 0.477 | 0.102 |
| (3) | θRn | 0.6598 | 0.6598 | 0.6598 | 0.6212 | 0.6495 |
| (4) | fM/fRn | −0.631 | −0.891 | −0.539 | −0.422 | −0.831 |
| (5) | fRn/fR | −1.354 | −1.014 | −1.760 | −3.338 | −1.381 |
| (6) | Sk/Ak | 1.934 | 1.896 | 1.793 | 1.835 | 1.842 |
| (7) | fl/f2 | −4.347 | −4.431 | −1.723 | −1.422 | −1.128 |
| (8) | ft/f2 | −8.451 | −7.998 | −2.567 | −1.324 | −2.325 |
| (a) | fRn | −75.700 | −64.070 | −96.227 | −132.703 | −83.765 |
| | surface | 30-32 | 30-38 | 32-39 | 31-33 | 25-31 |
| | incident direction cosine | −0.051 | −0.008 | 0.010 | −0.014 | 0.011 |
| | exit direction cosine | 0.143 | 0.230 | 0.151 | 0.032 | 0.153 |

While the disclosure has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2020-183668, filed Nov. 2, 2020, which is hereby incorporated by reference herein in its entirety.

What is claimed is:

1. A zoom lens comprising in order from an object side to an image side: a first lens unit having a positive refractive power and configured not to move for zooming; a second lens unit having a negative refractive power and configured to move in an optical axis direction for zooming; an M lens unit having a positive refractive power and configured to move in the optical axis direction for zooming; and an R lens unit having a positive refractive power and disposed closest to the image side,
wherein the first lens unit includes a lens subunit configured to move for focusing,
wherein the zoom lens includes an aperture stop closer to the image side than the second lens unit,
wherein following inequalities are satisfied:
0.65≤Sk/DR≤1.4, and
0.1<Ok/Sk<0.6,
where DR represents a length on the optical axis from a surface of the R lens unit closest to the object side to a surface of the R lens unit closest to the image side, Ok represents a length on the optical axis from the surface of the R lens unit closest to the image side to a rear principal point of the R lens unit, and Sk represents a back focus of the zoom lens.

2. The zoom lens according to claim 1, wherein a following inequality is satisfied:
0.61≤θRn≤0.68,
where θRn represents a partial dispersion ratio of an optical material of at least one negative lens, constituting a single lens or a cemented lens, in two lenses, closest to the object side, included in the R lens unit, the partial dispersion ratio θ being expressed as follows:
θ=(Ng−NF)/(NF−NC),
where Ng, NF and NC represent refractive indices of material with respect to g-line (wavelength 435.8 nm), F-line (wavelength 486.1 nm) and C-line (wavelength 656.3 nm), respectively.

3. The zoom lens according to claim 1, wherein a following inequality is satisfied:
−1.0≤fM/fRn<0,
where fM represents a combined focal length of the M lens unit and a lens unit having a positive refractive power and disposed adjacent to the M lens unit, and fRn represents a focal length of a negative lens subunit of the R lens unit, having a negative refractive power and including a lens closest to the object side in the R lens unit, the negative lens subunit increasing a degree of divergence of a beam that is incident on the negative lens subunit as a convergent beam or a collimated beam.

4. The zoom lens according to claim 1, wherein a following inequality is satisfied,
−3.5≤fRn/fR≤−0.8,
where fRn represents a focal length of a negative lens subunit of the R lens unit, having a negative refractive power and including a lens closest to the object side in the R lens unit, the negative lens subunit increasing a degree of divergence of a beam that is incident on the negative lens subunit as a convergent beam or a collimated beam, and fR represents a focal length of the R lens unit.

5. The zoom lens according to claim 1, wherein a following inequality is satisfied:
1.5≤Sk/Ak≤2.4,
where Ak represents an effective diameter of a lens disposed closest to the object side in the R lens unit.

6. The zoom lens according to claim 1, wherein a following inequality is satisfied:
−6.5<f/f2<−1.0,
where f1 represents a focal length of the first lens unit and f2 represents a focal length of the second lens unit.

7. The zoom lens according to claim 1, wherein a following inequality is satisfied:
−9.5≤ft/f2≤−1.2
where ft represents a focal length of the zoom lens at a telephoto end and f2 represents a focal length of the second lens unit.

8. The zoom lens according to claim 3, wherein the negative lens subunit converts the beam incident on the negative lens subunit as the convergent beam or the collimated beam into a divergent beam to emit from the negative lens subunit with an absolute value of a change amount of a direction cosine of an axial beam with respect to the optical axis being larger than 0.03, where the direction cosine takes a negative value for a convergent beam and takes a positive value for a divergent beam.

9. The zoom lens according to claim 4, wherein the negative lens subunit converts the beam incident on the negative lens subunit as the convergent beam or the collimated beam into a divergent beam to emit from the negative lens subunit with an absolute value of a change amount of a direction cosine of an axial beam with respect to the optical axis being larger than 0.03, where the direction cosine takes a negative value for a convergent beam and takes a positive value for a divergent beam.

10. An image pickup apparatus comprising a zoom lens, and an image pickup element configured to pick up an image formed by the zoom lens,
wherein the zoom lens comprising in order from an object side to an image side: a first lens unit having a positive refractive power and configured not to move for zooming; a second lens unit having a negative refractive power and configured to move in an optical axis direction for zooming; an M lens unit having a positive refractive power and configured to move in the optical axis direction for zooming; and an R lens unit having a positive refractive power and disposed closest to the image side,
wherein the first lens unit includes a lens subunit configured to move for focusing,
wherein the zoom lens includes an aperture stop closer to the image side than the second lens unit,
wherein following inequalities are satisfied:
0.65≤Sk/DR≤1.4, and
0.1<Ok/Sk<0.6,
where DR represents a length on the optical axis from a surface of the R lens unit closest to the object side to a surface of the R lens unit closest to the image side, Ok represents a length on the optical axis from the surface of the R lens unit closest to the image side to a rear principal point of the R lens unit, and Sk represents a back focus of the zoom lens.

11. The image pickup apparatus according to claim 10, wherein in the zoom lens, a following inequality is satisfied:
0.61≤θRn≤0.68,
where θRn represents a partial dispersion ratio of an optical material of at least one negative lens, constituting a single lens or a cemented lens, in two lenses, closest to the object side, included in the R lens unit, the partial dispersion ratio θ being expressed as follows:
θ=(Ng−NF)/(NF−NC),
where Ng, NF and NC represent refractive indices of material with respect to g-line (wavelength 435.8 nm), F-line (wavelength 486.1 nm) and C-line (wavelength 656.3 nm), respectively.

12. The image pickup apparatus according to claim 10, wherein in the zoom lens, a following inequality is satisfied:
−1.0≤fM/fRn<0,
where fM represents a combined focal length of the M lens unit and a lens unit having a positive refractive power and disposed adjacent to the M lens unit, and fRn represents a focal length of a negative lens subunit of the R lens unit, having a negative refractive power and including a lens closest to the object side in the R lens unit, the negative lens subunit increasing a degree of divergence of a beam that is incident on the negative lens subunit as a convergent beam or a collimated beam.

13. The image pickup apparatus according to claim 10, wherein in the zoom lens, a following inequality is satisfied,
−3.5≤fRn/fR≤−0.8,
where fRn represents a focal length of a negative lens subunit of the R lens unit, having a negative refractive power and including a lens closest to the object side in the R lens unit, the negative lens subunit increasing a degree of divergence of a beam that is incident on the negative lens subunit as a convergent beam or a collimated beam, and fR represents a focal length of the R lens unit.

14. The image pickup apparatus according to claim 10, wherein in the zoom lens a following inequality is satisfied:
1.5≤Sk/Ak≤2.4,
where Ak represents an effective diameter of a lens disposed closest to the object side in the R lens unit.

15. The image pickup apparatus according to claim 10, wherein in the zoom lens a following inequality is satisfied:
−6.5<f/f2<−1.0,
where f1 represents a focal length of the first lens unit and f2 represents a focal length of the second lens unit.

16. The image pickup apparatus according to claim 10, wherein in the zoom lens a following inequality is satisfied:
−9.5≤ft/f2≤−1.2
where ft represents a focal length of the zoom lens at a telephoto end and f2 represents a focal length of the second lens unit.

17. The image pickup apparatus according to claim 12, wherein in the zoom lens, the negative lens subunit converts the beam incident on the negative lens subunit as the convergent beam or the collimated beam into a divergent beam to emit from the negative lens subunit with an absolute value of a change amount of a direction cosine of an axial beam with respect to the optical axis being larger than 0.03, where the direction cosine takes a negative value for a convergent beam and takes a positive value for a divergent beam.

18. The image pickup apparatus according to claim 13, wherein in the zoom lens, the negative lens subunit converts the beam incident on the negative lens subunit as the convergent beam or the collimated beam into a divergent beam to emit from the negative lens subunit with an absolute value of a change amount of a direction cosine of an axial beam with respect to the optical axis being larger than 0.03, where the direction cosine takes a negative value for a convergent beam and takes a positive value for a divergent beam.
